(19) United States
(12) Patent Application Publication
(10) Pub. No.: US 2020/0262453 A1
(43) Pub. Date: Aug. 20, 2020

(54) PICK-UP MANAGEMENT DEVICE, PICK-UP CONTROL METHOD, AND STORAGE MEDIUM

(71) Applicant: HONDA MOTOR CO., LTD., Tokyo (JP)

(72) Inventors: Yoshitaka Mimura, Wako-shi (JP); Katsuyasu Yamane, Wako-shi (JP); Hiroshi Yamanaka, Wako-shi (JP); Chie Sugihara, Tokyo (JP); Yuki Motegi, Tokyo (JP); Tsubasa Shibauchi, Tokyo (JP)

(21) Appl. No.: 16/783,276

(22) Filed: Feb. 6, 2020

(30) Foreign Application Priority Data
Feb. 15, 2019 (JP) 2019-025954

(51) Int. Cl. B60W 60/00; G08G 1/00; G06Q 10/02; G06Q 50/30

(52) U.S. Cl. CPC B60W 60/00253; G06Q 50/30; G06Q 10/025; G08G 1/202

(57) ABSTRACT

A pick-up management device includes an acquirer configured to acquire first information about a situation of movement of a vehicle from a parking area to a stopping area, second information indicating a situation of the stopping area, and third information about occupant candidates who are present in or are approaching the stopping area and a pick-up mode determiner configured to associate one or more occupant candidates or one or more items of luggage with the vehicle on the basis of at least one of the first information, the second information, and the third information and determine a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

### CROSS-REFERENCE TO RELATED APPLICATION

Priority is claimed on Japanese Patent Application No. 2019-025954, filed Feb. 15, 2019, the content of which is incorporated herein by reference.

### BACKGROUND

### Field of the Invention

The present invention relates to a pick-up management device, a pick-up control method, and a storage medium.

### Description of Related Art

Conventionally, research has been conducted on automatically controlling vehicles. In connection with this, technology for determining a reservation time or a reservation order of entering/leaving on the basis of information in which a user using a mechanical parking lot has remotely made a reservation of entering/leaving and a predicted arrival time predicted from position information acquired from a communication terminal used by the user has been disclosed (Japanese Unexamined Patent Application, First Publication No. 2018-49514).

### SUMMARY

However, in the conventional technology, a period of time required for a user to get into or out of a vehicle is not considered and there is a possibility that a waiting period of time for a subsequent user may be long and a suitable reservation order of leaving may not be set when there is a user who requires significant time to get into or out of the vehicle due to a large amount of luggage or the like.

Aspects of the present invention have been made in consideration of such circumstances and an objective of the present invention is to provide a pick-up management device, a pick-up control method, and a storage medium capable of implementing smoother picking up.

A pick-up management device, a pick-up control method, and a storage medium according to aspects of the present invention adopt the following configurations.

(1): According to an aspect of the present invention, there is provided a pick-up management device including: an acquirer configured to acquire first information about a situation of movement of a vehicle from a parking area to a stopping area, second information indicating a situation of the stopping area, and third information about occupant candidates who are present in or are approaching the stopping area; and a pick-up mode determiner configured to associate one or more occupant candidates or one or more items of luggage with the vehicle on the basis of at least one of the first information, the second information, and the third information and determine a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

(2): In the above-described aspect (1), the pick-up mode determines a stop position of the vehicle.

(3): In the above-described aspect (2), the pick-up mode determiner estimates degrees of relation between the occupant candidates on the basis of the acquired information and determines the stop position so that a plurality of vehicles with a high degree of relation between the occupant candidates are stopped at mutually adjacent positions.

(4): In the above-described aspect (2), the pick-up mode determiner determines the stop position so that a vehicle having a large number of occupant candidates is stopped at a position near an occupant gate of the stopping area on the basis of at least one of the first information, the second information, and the third information.

(5): In the above-described aspect (2), the pick-up mode determiner estimates an amount of luggage to be loaded for each vehicle on the basis of at least one of the first information, the second information, and the third information and causes a vehicle having a large amount of luggage to be loaded to be stopped at a position near an occupant gate of the stopping area.

(6): In the above-described aspect (1), the pick-up mode determines a pick-up order of the vehicles.

(7): In the above-described aspect (6), the pick-up mode determiner estimates an amount of luggage to be loaded for each vehicle on the basis of at least one of the first information, the second information, and the third information and determines the pick-up order so that an arrival time of a second vehicle at the stopping area is later than an arrival time of a first vehicle at the stopping area when the first vehicle having a large amount of luggage to be loaded and the second vehicle with a high degree of relation to an occupant candidate of the first vehicle move to the stopping area.

(8): In the above-described aspect (7), the pick-up mode determiner further determines the pick-up order on the basis of an occupant classification of the occupant candidate that is ascertained on the basis of at least one of the first information, the second information, and the third information.

(9): In the above-described aspect (8), the occupant classification includes a gender of the occupant candidate, an age of the occupant candidate, a degree of difficulty when the occupant candidate gets into the vehicle, the presence or absence of the next schedule of the occupant candidate and a scheduled time thereof, and a scheduled movement distance of the occupant candidate.

(10): In the above-described aspect (6), the pick-up mode determiner estimates degrees of relation between the occupant candidates on the basis of at least one of the first information, the second information, and the third information and determines the pick-up order so that a vehicle associated with an occupant candidate having a low degree of relation to an occupant candidate related to a vehicles of occupant candidates having a high degree of relation is not stopped between the vehicles having the high degree of relation between the occupant candidates.

(11): In the above-described aspect (6), when the vehicles arriving at the stopping area form a vehicle queue and wait in front of the stopping area, the pick-up mode determiner causes the vehicles to be arranged at positions in the vehicle queue according to the pick-up order set by the pick-up mode determiner.

(12): In the above-described aspect (6), when it is proved that a communication unit that communicates with an external terminal has received a pick-up request for moving the vehicle from the parking area and have the occupant candidate ride on the vehicle at the stopping area, the acquirer estimates the degree of relation of the occupant candidate on the basis of position information of the external terminal transmitting the pick-up request received by the communication unit.

(13): In the above-described aspect (12), the acquirer acquires the position information of the external terminal transmitting the pick-up request as information indicating a situation of the stopping area, and the pick-up mode determiner estimates the degree of relation of the occupant candidate using the external terminal on the basis of the position information and determines the pick-up order.

(14): In the above-described aspect (12), when it is proved that the communication unit has collectively received pick-up requests for a plurality of vehicles to be stopped in the parking area from one external terminal, the pick-up mode determiner estimates the degree of relation between the plurality of vehicles on the basis of the pick-up requests and determines the pick-up order.

(15): In the above-described aspect (14), the pick-up mode determiner transmits information about an arrangement order of the plurality of vehicles to the external terminal by means of the communication unit and changes the pick-up mode in accordance with a received change request when the communication unit has received the change request for changing the pick-up mode of a user of the external terminal from the external terminal before arrival at the stopping area.

(16): In the above-described aspect (12), the pick-up mode manager sets an upper limit of approach of an inter-vehicle distance between the vehicles having a high degree of relation in accordance with a leaving trajectory and sizes of items of luggage of a following vehicle.

(17): In the above-described aspect (12), when another vehicle having a high degree of relation is already stopped in the stopping area, the pick-up mode determiner causes the vehicle to stop and wait behind the other vehicle.

(18): In the above-described aspect (14), the pick-up mode determiner recognizes vehicles into which occupant candidates having a high degree of relation get as a group and causes a following vehicle of the same group to stop within the stopping area if a predetermined condition is satisfied in a case in which a leading vehicle of the same group has arrived at the stopping area when the vehicle is waiting for an order to move to the stopping area.

(19): In the above-described aspect (18), the pick-up mode determiner limits an upper limit of the number of vehicles capable of being set as the same group in accordance with the allowable number of vehicles and an availability situation at the stopping area.

(20): In the above-described aspect (18), the pick-up mode determiner sets the occupant candidates joining the same event in the same group.

(21): In the above-described aspect (1), the pick-up mode determiner provides information about the determined pick-up mode to an external terminal used by the occupant candidate via a communication unit.

(22): According to an aspect of the present invention, there is provided a pick-up control method including: acquiring, by a computer, first information about a situation of movement of a vehicle from a parking area to a stopping area, second information indicating a situation of the stopping area, and third information about occupant candidates who are present in or are approaching the stopping area; associating, by the computer, one or more occupant candidates or one or more items of luggage with the vehicle on the basis of at least one of the first information, the second information, and the third information; and determining, by the computer, a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

(23): According to an aspect of the present invention, there is provided a computer-readable non-transitory storage medium storing a program for causing a computer to: acquire first information about a situation of movement of a vehicle from a parking area to a stopping area, second information indicating a situation of the stopping area, and third information about occupant candidates who are present in or are approaching the stopping area; associate one or more occupant candidates or one or more items of luggage with the vehicle on the basis of at least one of the first information, the second information, and the third information; and determine a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

According to the aspects (1) to (23), it is possible to perform picking up and leaving more efficiently in accordance with a situation.

According to the aspect (3), it is also possible to further implement a more suitable pick-up mode in accordance with a degree of relation between occupant candidates within a pick-up area.

### BRIEF DESCRIPTION OF THE DRAWINGS

FIG. 1 is a configuration diagram of a vehicle system.

FIG. 2 is a functional configuration diagram of a first controller and a second controller.

FIG. 3 is a diagram schematically showing a scene in which a self-traveling parking event is executed.

FIG. 4 is a diagram showing an example of a configuration of a parking lot management device.

FIG. 5 is a diagram showing an example of a configuration of a pick-up management device.

FIG. 6 is a diagram showing an example of occupant candidate information.

FIG. 7 is a diagram showing an example of vehicle information.

FIG. 8 is a diagram showing an example of pick-up area information.

FIG. 9 is a diagram shown to describe usage situations of a stopping area and a pick-up area.

FIG. 10 is an example of the transition of a screen displayed on an external terminal used by an occupant candidate when a pick-up request is transmitted.

FIG. 11 is a diagram shown to describe a usage situation of a stopping area and a pick-up area.

FIG. 12 is a diagram shown to describe a usage situation of a stopping area and a pick-up area.

FIG. 13 is a flowchart showing an example of a flow of a series of processes of the pick-up management device according to the first embodiment.

FIG. 14 is a flowchart showing an example of a flow of a series of processes of the pick-up management device according to the first embodiment.

FIG. 15 is a flowchart showing an example of a flow of a series of processes of the pick-up management device according to the first embodiment.

FIG. 16 is a configuration diagram of a vehicle system.

FIG. 17 is a functional configuration diagram of a first controller and a second controller of the automated driving control device.

FIG. 18 is a diagram showing an example of a hardware configuration of the automated driving control device according to the embodiment.

### DESCRIPTION OF EMBODIMENTS

Embodiments of a pick-up management device, a pick-up control method, and a storage medium of the present invention will be described below with reference to the drawings.

### First Embodiment

### [Overall Configuration]

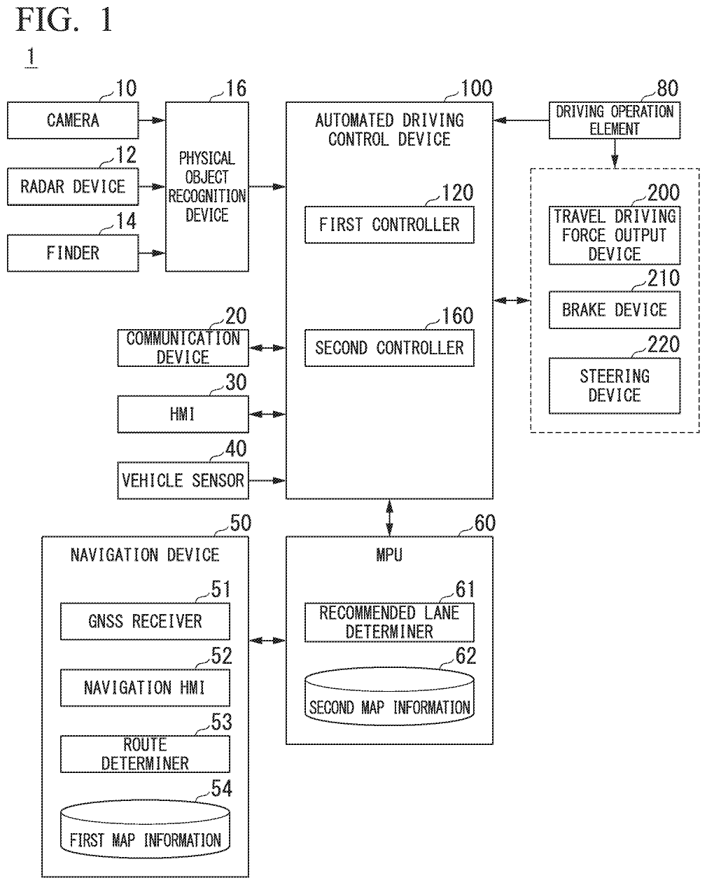

FIG. 1 is a configuration diagram of a vehicle system 1. Although a vehicle is not limited to an automated driving vehicle for the purposes of the present invention, the automated driving vehicle will be described as an example in the following description. For example, a vehicle on which the vehicle system 1 is mounted is, for example, a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power generated from an electric power generator connected to the internal combustion engine or discharge electric power of a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operation element 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example, a part of the configuration may be omitted, and another configuration may be further added. The automated driving control device 100 is an example of a “driving control device”.

For example, the camera 10 is a digital camera using a solid-state imaging element such as a charge coupled device (CCD) or a complementary metal oxide semiconductor (CMOS). The camera 10 is attached to any position on the vehicle (hereinafter, a vehicle M) on which the vehicle system 1 is mounted. When the view in front of the vehicle M is imaged, the camera 10 is attached to an upper part of a front windshield, a rear surface of a rearview mirror, or the like. For example, the camera 10 periodically and iteratively images the surroundings of the vehicle M. The camera 10 may be a stereo camera.

The radar device 12 radiates radio waves such as millimeter waves around the vehicle M and detects at least a position (a distance to and a direction) of a physical object by detecting radio waves (reflected waves) reflected by the physical object. The radar device 12 is attached to any position on the vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the vehicle M and measures scattered light. The finder 14 detects a distance to an object on the basis of time from light emission to light reception. The radiated light is, for example, pulsed laser light. The finder 14 is attached to any position on the vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving control device 100. The physical object recognition device 16 may output detection results of the camera 10, the radar device 12, and the finder 14 to the automated driving control device 100 as they are. The physical object recognition device 16 may be omitted from the vehicle system 1.

The communication device 20 communicates with another vehicle or another device present in the vicinity of the vehicle M using, for example, a cellular network or a Wi-Fi network, Bluetooth (registered trademark), dedicated short range communication (DSRC), or the like.

The HMI 30 presents various types of information to an occupant of the vehicle M and receives an input operation of the occupant. The HMI 30 includes various types of display devices, a speaker, a buzzer, a touch panel, a switch, keys, and the like.

The vehicle sensor 40 includes a vehicle speed sensor configured to detect the speed of the vehicle M, an acceleration sensor configured to detect acceleration, a yaw rate sensor configured to detect an angular speed around a vertical axis, a direction sensor configured to detect a direction of the vehicle M, and the like.

For example, the navigation device 50 includes a global navigation satellite system (GNSS) receiver 51, a navigation HMI 52, and a route determiner 53. The navigation device 50 stores first map information 54 in a storage such as a hard disk drive (HDD) or a flash memory. The GNSS receiver 51 identifies a position of the vehicle M on the basis of a signal received from a GNSS satellite. The position of the vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of a terminal device such as a smartphone or a tablet terminal possessed by the occupant. The navigation device 50 may transmit a current position and a destination to a navigation server via the communication device 20 and acquire a route equivalent to the route on the map from the navigation server.

For example, the MPU 60 includes a recommended lane determiner 61 and stores second map information 62 in a storage such as an HDD or a flash memory. The recommended lane determiner 61 divides the route on the map provided from the navigation device 50 into a plurality of blocks (for example, divides the route every 100 [m] with respect to a traveling direction of the vehicle), and determines a recommended lane for each block with reference to the second map information 62. The recommended lane determiner 61 determines what number lane the vehicle travels in from the left. The recommended lane determiner 61 determines the recommended lane so that the vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/zip code), facility information, telephone number information, and the like. The second map information 62 may be updated at any time when the communication device 20 communicates with another device.

For example, the driving operation element 80 includes an accelerator pedal, a brake pedal, a shift lever, a steering wheel, a steering wheel variant, a joystick, and other operation elements. A sensor configured to detect an amount of operation or the presence or absence of an operation is attached to the driving operation element 80, and a detection result thereof is output to the automated driving control device 100 or some or all of the travel driving force output device 200, the brake device 210, and the steering device 220.

The automated driving control device 100 includes, for example, a first controller 120 and a second controller 160. The first controller 120 and the second controller 160 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by cooperation between software and hardware. The program may be pre-stored in a storage such as an HDD or a flash memory of the automated driving control device 100 (a storage including a non-transitory storage medium) or may be installed in the HDD or the flash memory of the automated driving control device 100 when the program is stored in a removable storage medium such as a DVD or a CD-ROM and the storage medium (the non-transitory storage medium) is mounted in a drive device.

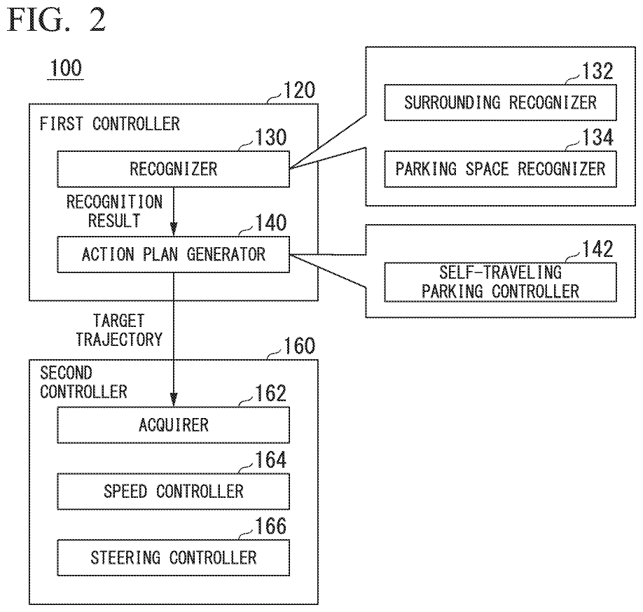

FIG. 2 is a functional configuration diagram of the first controller 120 and the second controller 160. The first controller 120 includes, for example, a recognizer 130, and an action plan generator 140. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions. Thereby, the reliability of automated driving is secured.

The recognizer 130 includes a surrounding recognizer 132 and a parking space recognizer 134. The surrounding recognizer 132 recognizes a state such as a position, velocity, or acceleration of a physical object present in the vicinity of the vehicle M on the basis of information input from the camera 10, the radar device 12, and the finder 14 via the physical object recognition device 16. For example, the position of the physical object is recognized as a position on absolute coordinates with a representative point (a center of gravity, a driving shaft center, or the like) of the vehicle M as the origin and is used for control. The position of the physical object may be represented by a representative point such as a center of gravity or a corner of the physical object or may be represented by a represented region. The “state” of a physical object may include acceleration or jerk of the physical object or an “action state” (for example, whether or not a lane change is being made or intended).

For example, the surrounding recognizer 132 recognizes a lane in which the vehicle M is traveling (a travel lane). For example, the surrounding recognizer 132 recognizes the travel lane by comparing a pattern of a road dividing line (for example, an arrangement of solid lines and broken lines) obtained from the second map information 62 with a pattern of road dividing lines in the vicinity of the vehicle M recognized from an image captured by the camera 10. The surrounding recognizer 132 may recognize a travel lane by recognizing a traveling path boundary (a road boundary) including a road dividing line, a road shoulder, a curb stone, a median strip, a guardrail, or the like as well as a road dividing line. In this recognition, a position of the vehicle M acquired from the navigation device 50 or a processing result of the INS may be added. The surrounding recognizer 132 recognizes a temporary stop line, an obstacle, red traffic light, a toll gate, and other road events.

When the travel lane is recognized, the surrounding recognizer 132 recognizes a position or orientation of the vehicle M with respect to the travel lane. For example, the surrounding recognizer 132 may recognize a gap of a reference point of the vehicle M from the center of the lane and an angle formed with respect to a line connecting the center of the lane in the travel direction of the vehicle M as a relative position and orientation of the vehicle M related to the travel lane. Alternatively, the recognizer 130 may recognize a position of the reference point of the vehicle M related to one side end portion (a road dividing line or a road boundary) of the travel lane or the like as a relative position of the vehicle M related to the travel lane.

Details of the function of the parking space recognizer 134 will be described below.

The action plan generator 140 generates a future target trajectory along which the vehicle M automatically travels (independently of a driver's operation) so that the vehicle M can generally travel in the recommended lane determined by the recommended lane determiner 61 and further cope with a surrounding situation of the vehicle M. For example, the target trajectory includes a speed element. For example, the target trajectory is represented by sequentially arranging points (trajectory points) at which the vehicle M is required to arrive. The trajectory point is a point where the vehicle M is required to reach for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the vehicle M is required to arrive at the sampling time for each predetermined sampling time. In this case, information about the target speed or the target acceleration is represented by an interval between the trajectory points.

The action plan generator 140 determines an event of automated driving on the route on which a recommended lane has been determined. The event is information that defines a traveling mode of the vehicle M. The automated driving is a process of causing the vehicle M to travel while controlling one or both of the steering and the speed of the vehicle M independently of an operation on the driving operation element 80 by the occupant of the vehicle M. On the other hand, in the manual driving, the steering and the speed of the vehicle M are controlled in accordance with an operation of the occupant on the driving operation element 80. The event of the automated driving is information defining the behavior to be taken by the vehicle M under the above-described automated driving, i.e., a driving mode.

The events include, for example, a parking event in which the occupant of the vehicle M does not park the vehicle M in the parking space but the vehicle M autonomously travels to be parked in the parking space as in valet parking, a stop event for causing the vehicle M to be stopped at a place, an advancing event for causing the vehicle M to move forward while the vehicle M is being slowly moved, a reversing event for causing the vehicle M to move backward while the vehicle M is being slowly moved, and the like.

The events include, for example, a constant-speed traveling event for causing the vehicle M to travel in the same lane at a constant speed, a following traveling event for causing the vehicle M to follow another vehicle (hereinafter referred to as a preceding vehicle) that is present within a prescribed distance (for example, within 100 [m]) in front of the vehicle M and is closest to the vehicle M, a lane change event for causing the vehicle M to make a lane change from the host vehicle lane to an adjacent lane, an branching event for causing the vehicle M to join a lane of a branch road in a target direction at a branch point of a road, a merging event for causing the vehicle M to join a lane of a main road at a merging point, an overtaking event for causing the vehicle M to make a lane change to a previous lane again after the vehicle M temporarily makes a lane change to an adjacent lane and overtakes a preceding vehicle in the adjacent lane, an avoidance event for causing the vehicle M to perform at least one of braking and steering in order to avoid an obstacle in front of the vehicle M, and a takeover event for ending automated driving and performing switching to manual driving, and the like. “Following” may be, for example, a traveling mode for causing a relative distance (an inter-vehicle distance) between the vehicle M and the preceding vehicle to be constantly maintained or a traveling mode for causing the vehicle M to travel in the center of the host vehicle lane in addition to causing the relative distance between the vehicle M and the preceding vehicle to be constantly maintained.

The action plan generator 140 may change an event already determined with respect to the current section or the next section to another event, or determine a new event with respect to the current section or the next section, in accordance with a surrounding situation recognized by the recognizer 130 when the vehicle M travels.

The action plan generator 140 generates a future target trajectory for causing the vehicle M to automatically travel in a traveling mode determined by the event (independently of the driver's operation) so that the vehicle M generally travels in a recommended lane determined by the recommended lane determiner 61 and the vehicle M further copes with a surrounding situation when the vehicle M travels in the recommended lane. The target trajectory includes, for example, a position element that determines the future position of the vehicle M and a speed element that determines the speed, acceleration, and the like of the vehicle M in the future.

For example, the action plan generator 140 determines a plurality of points (trajectory points) at which the vehicle M is required to sequentially arrive as position elements of the target trajectory. The trajectory point is a point at which the host vehicle M is required to arrive for each predetermined travel distance (for example, about several [m]). The predetermined traveling distance may be calculated, for example, according to a road distance when the host vehicle M travels along a route.

The action plan generator 140 determines a target speed and target acceleration for each prescribed sampling time (for example, about several tenths of a second [sec]) as speed elements of the target trajectory. The trajectory point may be a position at which the host vehicle M is required to arrive at the sampling time at each prescribed sampling time. In this case, the target speed or the target acceleration is determined by a sampling period of time and an interval between the trajectory points. The action plan generator 140 outputs information indicating the generated target trajectory to the second controller 160.

For example, the action plan generator 140 includes a self-traveling parking controller 142 to be activated when a self-traveling parking event is executed. Details of a function of the self-traveling parking controller 142 will be described below.

Returning to FIG. 1, the second controller 160 controls the travel driving force output device 200, the brake device 210, and the steering device 220 so that the vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information of a target trajectory (a trajectory point) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the vehicle M and feedback control based on a deviation from the target trajectory in combination.

The travel driving force output device 200 outputs a travel driving force (torque) for driving the vehicle to the drive wheels. The travel driving force output device 200 includes, for example, a combination of an internal combustion engine, an electric motor, a transmission, and the like, and an electronic controller (ECU) that controls these components. The ECU controls the above-described components in accordance with information input from the second controller 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated by an operation of the brake pedal included in the driving operation element 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operation element 80 to change the direction of the steerable wheels.

### [Self-Traveling Parking Event-Time of Entering]

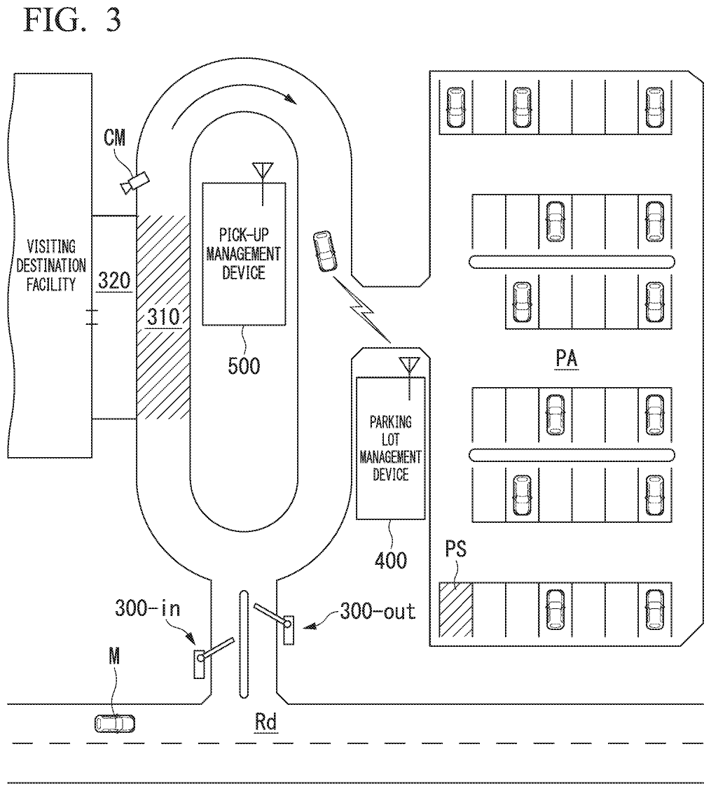

For example, the self-traveling parking controller 142 causes the vehicle M to be parked within a parking space in the second parking area on the basis of information acquired from the parking lot management device 400 by means of the communication device 20. FIG. 3 is a diagram schematically showing a scene in which a self-traveling parking event is executed. Gates 300-In and 300-out are provided on a route from a road Rd to a visiting destination facility. The vehicle M proceeds to a stopping area 310 through the gate 300-in according to manual driving or automated driving. The stopping area 310 faces a pick-up area 320 connected to the visiting destination facility. The pick-up area 320 is provided with eaves for avoiding rain and snow.

A case in which a camera CM for imaging a state in which a user within the pick-up area 320 gets into or out of the vehicle is provided in the pick-up area 320 will be described. The pick-up management device 500 will be described below.

After the occupant gets out of the vehicle M in the stopping area 310, the vehicle M performs unmanned automated driving and starts the self-traveling parking event in which the vehicle M moves to the parking space PS within the parking area PA. For example, a start trigger of the self-traveling parking event may be, for example, any operation of an occupant or may be the wireless reception of a predetermined signal from the parking lot management device 400. When the self-traveling parking event starts, the self-traveling parking controller 142 controls the communication device 20 so that the communication device 20 transmits a parking request to the parking lot management device 400. The vehicle M moves from the stopping area 310 to the parking area PA in accordance with guidance of the parking lot management device 400 or while performing sensing independently.

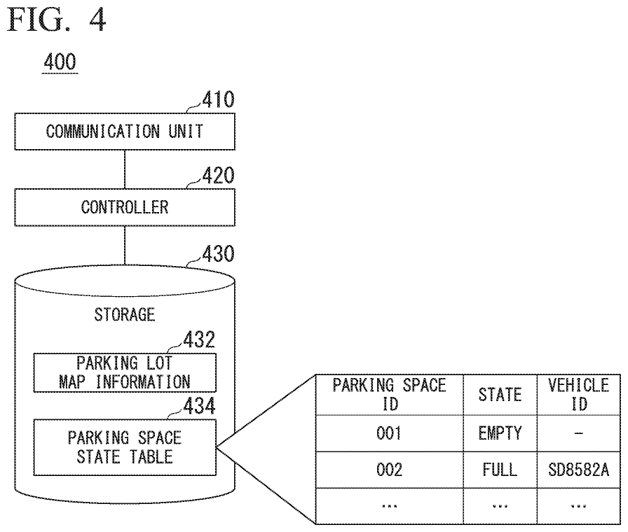

FIG. 4 is a diagram showing an example of the configuration of the parking lot management device 400. The parking lot management device 400 includes, for example, a communication unit 410, a controller 420, and a storage 430. The storage 430 stores information such as parking lot map information 432 and a parking space state table 434.

The communication unit 410 wirelessly communicates with the vehicle M and other vehicles. The controller 420 guides the vehicle to parking space PS on the basis of information acquired by the communication unit 410 and information stored in storage 430. The parking lot map information 432 is information geometrically indicating structures of the parking area PA. The parking lot map information 432 includes coordinates for each parking space PS. In the parking space state table 434, for example, a state which is an empty state or a full (parked) state and a vehicle ID which is identification information of a vehicle during parking in the case of the full state are associated with a parking space ID which is identification information of the parking space PS.

When the communication unit 410 receives a parking request from the vehicle, the controller 420 extracts the parking space PS whose state is the empty state with reference to the parking space state table 434, acquires a position of the extracted parking space PS from the parking lot map information 432, and transmits a suitable route to the acquired position of the parking space PS to the vehicle using the communication unit 410. The controller 420 instructs a specific vehicle to stop or slow down as necessary so that the vehicles do not move to the same position at the same time on the basis of positional relationships of a plurality of vehicles.

In the vehicle (hereinafter referred to as the vehicle M) receiving a route, the self-traveling parking controller 142 generates a target trajectory based on the route. When the vehicle M approaches the target parking space PS, the parking space recognizer 134 recognizes parking frame lines that divide off the parking space PS and the like, recognizes a detailed position of the parking space PS, and provides the recognized position to the self-traveling parking controller 142. The self-traveling parking controller 142 receives the provided position to correct the target trajectory and cause the vehicle M to be parked in the parking space PS.

### [Self-Traveling Parking Event-Time of Leaving]

The self-traveling parking controller 142 and the communication device 20 maintain the operation state even when the vehicle M has been parked. The self-traveling parking controller 142 causes a system of the vehicle M to be activated and causes the vehicle M to be moved to the stopping area 310, for example, when the communication device 20 has received a pick-up request for requesting a process of moving the vehicle M from the parking area PA and allowing an occupant candidate to get into the vehicle M in the stopping area 310 from a terminal device used by the occupant candidate. Occupant candidates include a person transmitting the pick-up request to the vehicle M or an accompanying person thereof and an occupant who was in the vehicle M before the vehicle M enters the parking area and are persons who are likely to get into the vehicle M at the time of leaving. Therefore, there is a possibility that a vehicle with which an occupant candidate is associated as an occupant will not be known before the occupant candidate actually gets into the vehicle. The pick-up request may be a request for causing the vehicle M to immediately leave the parking area and starting the movement to the stopping area 310, a request for designating a scheduled leaving time when the movement to the stopping area 310 starts, or a request for designating a scheduled arrival time at the stopping area 310 (a desired arrival time).

At this time, the self-traveling parking controller 142 controls the communication device 20 so that the communication device 20 transmits a departure request including information about the scheduled leaving time or the scheduled arrival time (the desired arrival time) at the stopping area 310 included in the pick-up request to the pick-up management device 500. The pick-up management device 500 instructs a specific vehicle to stop or slow down as necessary so that the vehicles do not move to the same position at the same time on the basis of a positional relationship between a plurality of vehicles. The pick-up management device 500 performs management so that the vehicles do not move to the same position at the same time by predicting a starting time of movement of each vehicle to the stopping area 310, a positional relationship between vehicles during the movement, whether or not a predetermined number of vehicles or more move to the stopping area 310 within a predetermined period of time (whether or not there is a vehicle which waits for an empty space to be created in the stopping area 310 outside the stopping area 310), and the like. When the times at which a plurality of vehicles are desired to arrive at the stopping area 310 overlap, the pick-up management device 500 adjusts the scheduled arrival times in accordance with a reception order of pick-up requests or in mediation with each occupant candidate. When the vehicle M is moved to the stopping area 310 and the occupant candidate is allowed to get into the vehicle M, the self-traveling parking controller 142 stops the operation and the manual driving or the automated driving by another functional unit is subsequently started. When the vehicle M starts moving to the stopping area 310 or when the vehicle M has arrived at the stopping area 310, the self-traveling parking controller 142 may control the communication device 20 so that the communication device 20 notifies a terminal device of the occupant candidate of information about a state and a position of the vehicle M.

Although the parking lot management device 400 and the pick-up management device 500 are shown as different devices in FIG. 3, the parking lot management device 400 and the pick-up management device 500 may be configured as an integrated device.

The self-traveling parking controller 142 may find an empty parking space by itself on the basis of the detection result of the camera 10, the radar device 12, the finder 14, or the physical object recognition device 16 independently of communication and cause the vehicle M to be parked in the found parking space without being limited to the above description. In relation to the time of leaving, likewise, the vehicle M may be independently moved to the stopping area 310 independently of communication.

### [Pick-Up Management Device]

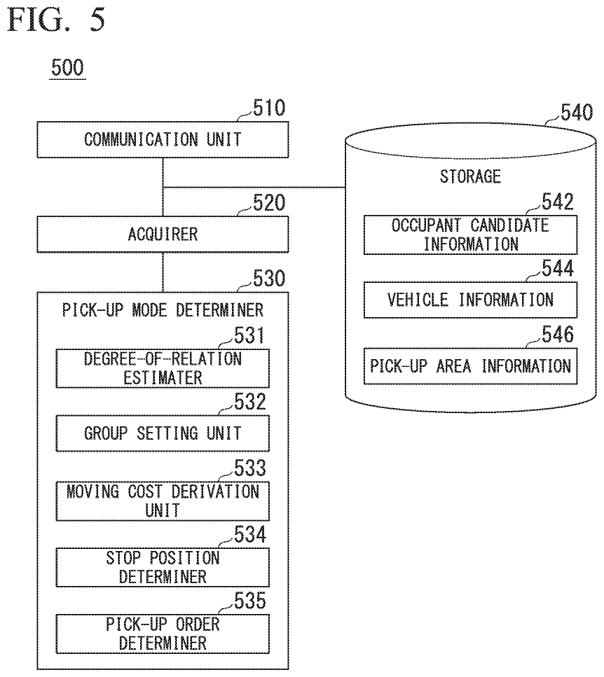

FIG. 5 is a diagram showing an example of a configuration of the pick-up management device 500. The pick-up management device 500 includes, for example, a communication unit 510, an acquirer 520, a pick-up mode determiner 530, and a storage 540. The storage 540 stores information such as occupant candidate information 542, vehicle information 544, and pick-up area information 546.

The communication unit 510 wirelessly communicates with the vehicle M and other vehicles. The communication unit 510 further communicates with the parking lot management device 400 and other devices (for example, a device that manages the activity state of the occupant candidates of the vehicle M in the visiting destination facility, a device that recognizes the occupant candidates within the pick-up area 320, and the like) according to wired or wireless communication.

The acquirer 520 acquires information about occupant candidates who are present in or are approaching the pick-up area from results of communication of the communication unit 510 with other devices and causes the information to be stored as the occupant candidate information 542 of the storage 540. The acquirer 520 acquires information about a situation of movement of the vehicle from the parking area PA to the stopping area 310 from the results of communication with the other devices received by the communication unit 510 and causes the information to be stored as the vehicle information 544 of the storage 540. The acquirer 520 acquires information indicating situations of the stopping area 310 and the pick-up area 320 (for example, the number of vehicles capable of being accommodated in the stopping area 310 and an availability situation at the stopping area 310) from the information acquired by the communication unit 510 and causes the information to be stored as the pick-up area information 546 of the storage 540. The occupant candidate information 542, the vehicle information 544, and the pick-up area information 546 will be described below.

The pick-up mode determiner 530 determines a pick-up mode of each vehicle on the basis of various types of information acquired by the acquirer 520. The pick-up mode includes, for example, an order in which the vehicles are permitted to use the stopping area 310 (hereinafter, a pick-up order), a stop position in the stopping area 310, an inter-vehicle interval between vehicles within the stopping area 310, and the like. For example, the pick-up mode determiner 530 predicts that each vehicle will move to the stopping area 310 on the basis of the scheduled leaving time or the scheduled arrival time included in the departure request received from each vehicle. The pick-up mode determiner 530 predicts the scheduled arrival time of the vehicle transmitting the departure request at the stopping area 310 on the basis of the departure request for requesting immediate leaving. The pick-up mode determiner 530 predicts the scheduled leaving time of the vehicle transmitting the departure request for the stopping area 310, a movement route after the start of movement, and the like on the basis of the scheduled arrival time included in the departure request.

The pick-up mode determiner 530 associates one or more occupant candidates or luggage with the vehicle on the basis of various types of information acquired by the acquirer 520 and determines the pick-up mode in the stopping area 310 of the vehicle on the basis of at least some of the number of occupant candidates for each vehicle in the stopping area 310, the number of items or sizes of items of luggage for each vehicle, and priorities of the occupant candidates when a predetermined number of vehicles or more are predicted to move to the stopping area 310 within a predetermined period of time.

The pick-up mode determiner 530 determines a pick-up order of vehicles and transmits a determination result to each vehicle via the communication unit 510. The pick-up mode determiner 530 determines a stop position of the vehicle in the pick-up area 320 and transmits a determination result to each vehicle via the communication unit 510. Each vehicle moves to the stopping area 310 in a pick-up mode of a determination result received from the pick-up management device 500. In the pick-up order, in addition to an arrangement order of vehicles when the vehicles are stopped in the stopping area 310, an arrangement order in a vehicle queue in a case in which a host vehicle waits for a space where the host vehicle is stopped to be available while forming the vehicle queue in front of the stopping area 310 at the time of movement from the parking area PA to the stopping area 310 may be included. When the vehicles arriving at the stopping area 310 form a vehicle queue and wait in front of the stopping area 310, the pick-up mode determiner 530 causes the vehicle to be arranged at a position in the vehicle queue according to the pick-up order set by the pick-up mode determiner 530.

The pick-up mode determiner 530 determines the pick-up mode as described above at least when the pick-up request has been received. In addition, the pick-up mode determiner 530 may iteratively perform the above process during the movement from the parking area PA or when the vehicle forms a vehicle queue and waits in front of the stopping area 310.

The pick-up mode determiner 530 includes, for example, a degree-of-relation estimater 531, a group setting unit 532, a moving cost derivation unit 533, a stop position determiner 534, and a pick-up order determiner 535. The degree-of-relation estimater 531 estimates a degree of relation between an occupant candidate and another occupant candidate. The group setting unit 532 performs group setting so that vehicles associated with occupant candidates having a high degree of relation therebetween can be identified on the basis of the degree of relation estimated by the degree-of-relation estimater 531. The moving cost derivation unit 533 derives a moving cost with reference to the occupant candidate information 542 of the occupant candidate of each vehicle. The moving cost will be described below.

The stop position determiner 534 determines the stop position of the vehicle in the stopping area 310 on the basis of the degree of relation between the occupant candidates estimated by the degree-of-relation estimater 531, the group setting performed by the group setting unit 532, and the moving cost derived by the moving cost derivation unit 533. For example, the stop position is an absolute position at which the front end of the vehicle is aligned or an inter-vehicle distance from a preceding vehicle.

The pick-up order determiner 535 determines the pick-up order of the vehicles on the basis of the degree of relation between the occupant candidates estimated by the degree-of-relation estimater 531, the group setting set by the group setting unit 532, and the moving cost derived by the moving cost derivation unit 533.

The pick-up order determiner 535 may determine the pick-up order on the basis of an occupant classification of the occupant candidate that is ascertained on the basis of various types of information in the storage 540. The occupant classification will be described below.

### [Occupant Candidate Information]

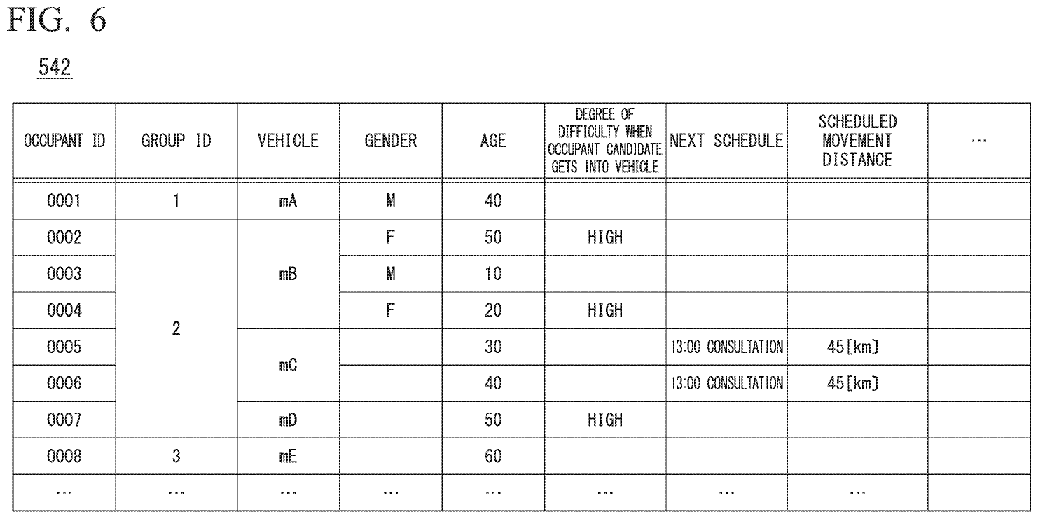

FIG. 6 is a diagram showing an example of the occupant candidate information 542. As in the example shown in FIG. 6, the occupant candidate information 542 includes a group ID indicating a relationship between the occupant candidates, vehicle information (for example, information for identifying a vehicle into which the occupant candidate has got, and information of a vehicle into which the occupant candidate desires to get reported by the occupant candidate), a gender, an age, a degree of difficulty when the occupant candidate gets into the vehicle, the presence/absence of the next schedule after a pick-up and a scheduled time thereof, a scheduled movement distance, and information such as priority at the time of a getting-into/out process set by the acquirer 520 on the basis of the above information. The degree of difficulty when the occupant candidate gets into the vehicle is an index indicating a possibility that a long period of time will be required when the occupant candidate gets into or out of the vehicle. For example, the acquirer 520 sets a high degree of difficulty when the occupant candidate gets into the vehicle for an occupant candidate requiring assistance from another person when he/she gets into or out of the vehicle, an occupant candidate who is carrying a large amount of luggage per occupant candidate, an infant or elderly occupant candidate, an occupant candidate using a wheelchair or a cane, and the like. The priority at the time of the getting-into/out process is an index when a position where the vehicle associated with each occupant candidate is stopped is determined by comparing occupant candidates using the pick-up area 320 in the same time period according to information such as the degree of difficulty when the occupant candidate gets into the vehicle, the presence or absence of the next schedule after the pick-up and the scheduled time thereof, and the scheduled movement distance. The acquirer 520 sets the priority of the occupant candidate having a high degree of difficulty when the occupant candidate gets into the vehicle to high priority and preferentially assigns the pick-up area 320 at a position where it is easy to get into or out of the vehicle. In the priority at the time of the getting-into/out process, the status of the occupant candidate at the visiting destination facility (for example, a position or an official position, membership, a degree of contribution, an amount of money of purchase, a length of stay, or the like at the visiting destination facility) may be considered. The priority at the time of the getting-into/out process may be represented by evaluation categories such as “high”, “medium”, and “low” or may be ranked. In the following description, characteristics of the occupant candidates ascertained on the basis of the information included in the occupant candidate information 542 are referred to as occupant classifications. Although an example in which each occupant candidate is associated with a vehicle is shown in FIG. 6, a record of occupant candidate information 542 that does not have vehicle information is assumed to be generated when it is not possible to predict which vehicle the occupant candidate will get into.

For example, the degree-of-relation estimater 531 estimates that the degree of relation between the occupant candidates is high when it is clear that the occupant candidates are a family, friends, colleagues, or the like, when a group to which the occupant candidates belong is the same, when the occupant candidates have visited a visiting destination facility for the purpose of joining the same event, or when the next destination is the same after the occupant candidates left the visiting destination facility. The same event is, for example, the four ceremonial occasions, a conference, a ceremony, a social gathering, an offline party, a symposium, a gathering, or the like. For example, the degree-of-relation estimater 531 identifies an event in which the occupant candidate participates by making an inquiry about a scheduler of the external terminal used by the occupant candidate, schedule registration information of a device that manages the activity state of the occupant candidate of the vehicle M at the visiting destination facility, or the like via the communication unit 510.

The group setting unit 532 sets a group ID for each occupant candidate on the basis of the degree of relation estimated by the degree-of-relation estimater 531 as information indicating the degree of relation between the occupant candidates. The group setting unit 532 sets the same group ID for the occupant candidates estimated to get into the same vehicle. The group setting unit 532 sets the same group ID when a plurality of occupant candidates are predicted to be divided and get into different vehicles, but the occupant candidates are highly related and estimated to desire to leave at the same time.

For example, when a device for recognizing occupant candidates using an image captured by the camera CM that images the pick-up area 320 is installed, the acquirer 520 creates the occupant candidate information 542 by recognizing each of the occupants getting out of the vehicle. The occupant candidate information 542 may be created from a part or all of information acquired from the device that manages the activity state of the occupant candidate when the device that manages the activity state of the occupant candidate of the vehicle M in the visiting destination facility and the pick-up management device 500 can communicate with each other. The above-described setting of the group ID may be performed when each vehicle leaves the parking area PA, may be iteratively performed each time a new vehicle is parked in the parking area PA, or may be performed iteratively at regular intervals. The above-described setting of the group ID may be reset each time a vehicle has completed the self-traveling parking event at the time of the leaving process in the stopping area 310.

The acquirer 520 may recognize the occupant candidate by acquiring an image including the occupant candidate of the pick-up area 320 imaged by the camera 10 of each vehicle via the communication unit 510 in addition to an image captured by the camera CM.

### [Vehicle Information]

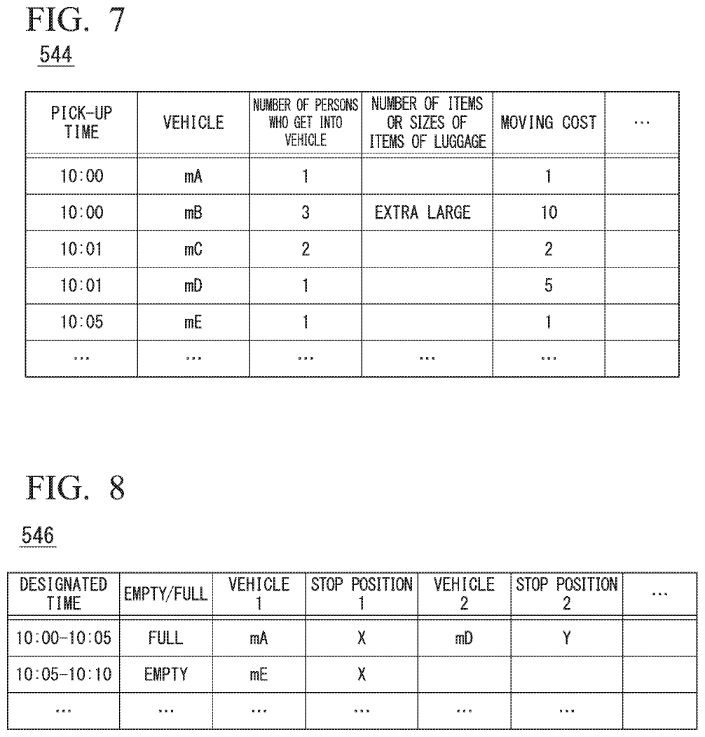

FIG. 7 is a diagram showing an example of the vehicle information 544. The vehicle information 544 includes, for example, information such as a pick-up time indicating a scheduled arrival time at the stopping area 310 set on the basis of the pick-up request, information for identifying the vehicle, the number of persons who get into the vehicle, the number of items or sizes of items of luggage carried by the occupant candidate scheduled to get into the vehicle, and a moving cost. The number of persons who get into the vehicle may be assumed to be, for example, the same as the number of occupants in the vehicle at the time of the getting-out process or may be obtained by receiving an input of whether or not the number of occupants has increased or decreased from the user transmitting the pick-up request. The moving cost is an index derived from the scheduled number of occupants per vehicle, an amount of luggage to be carried, an occupant classification of the occupant candidate (for example, the age and the degree of difficulty when the occupant candidate gets into the vehicle in the occupant candidate information 542), and the like. The fact that the moving cost is high indicates that a longer period of time is determined to be required to get into or out of the vehicle. The moving cost derivation unit 533 derives a moving cost for each vehicle with reference to the occupant candidate information 542 and the vehicle information 544.

### [Pick-Up Area Information]

FIG. 8 is a diagram showing an example of the pick-up area information 546. The pick-up area information 546 includes, for example, information such as an availability situation at the stopping area 310 scheduled for use at each designated time, information for identifying the vehicle for which the stopping area 310 is reserved at that time, and a stop position (coordinates or the like) of the vehicle. As the designated time, scheduled pick-up times of a plurality of vehicles are generally managed. For example, a scheduled time at which the vehicle arrives at the stopping area 310 and a scheduled time at which the vehicle completes the pick-up and leaves the stopping area 310 are managed.

### [Pick-Up Mode]

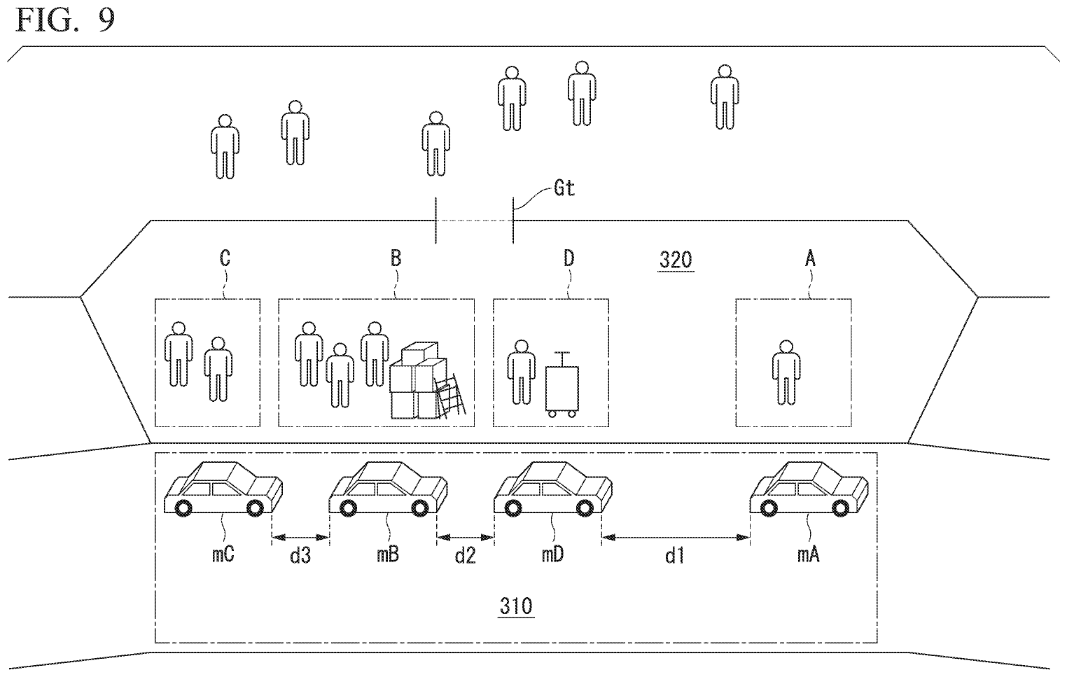

Hereinafter, a process of the pick-up mode determiner 530 will be described. FIG. 9 is a diagram shown to describe usage situations of the stopping area 310 and the pick-up area 320. A case in which an occupant gate Gt is provided in the pick-up area 320 at the visiting destination facility and each of the occupant candidates passes through the occupant gate Gt and moves to the pick-up area 320 immediately before or after the vehicle into which he/she will get arrives at the stopping area 310 will be described.

The pick-up mode determiner 530 determines the pick-up mode of each vehicle in the stopping area 310 on the basis of the number of occupant candidates of each vehicle, the number of items or sizes of items of luggage of each vehicle, or priorities of the occupant candidates at the time of the getting-into/out process. For example, the pick-up mode determiner 530 makes a determination so that a vehicle associated with an occupant candidate having high priority at the time of the getting-into/out process is preferentially stopped at a position at a short movement distance from the occupant gate Gt of FIG. 9 (a stop position of a vehicle mB or a vehicle mC in FIG. 9) as a position where it is easy to use the stopping area 310.

When occupant candidates scheduled to get into or out of vehicles have the same priority at the time of the getting-into/out process, the pick-up mode determiner 530 determines the pick-up mode of each vehicle in the stopping area 310 on the basis of the number of occupant candidates of each vehicle and the number of items or sizes of items of luggage of each vehicle. In the following description, a case in which priorities of the occupant candidates at the time of the getting-into/out process shown in FIG. 9 have the same priority will be described.

The pick-up mode determiner 530 associates a plurality of occupant candidates with vehicles stopped (or scheduled to be stopped) in the stopping area 310 on the basis of information of the storage 540, estimates a degree of relation between the occupant candidates on the basis of various types of information of the storage 540, and determines stop positions so that a plurality of vehicles having a high degree of relation between the occupant candidates are stopped at mutually adjacent positions. The fact that vehicles are stopped at adjacent positions indicates that no other vehicle is stopped between vehicles having a high degree of relation, for example, such as the vehicle mB, the vehicle mC, and a vehicle mD of FIG. 9. Stopping vehicles at adjacent positions may include stopping vehicles at near positions in a direction that is the same as a traveling direction of the vehicles (a longitudinal direction) or stopping vehicles at near positions side by side in a direction parallel to the traveling direction of the vehicles (a lateral direction).

The pick-up mode determiner 530 determines a stop position so that an inter-vehicle distance d1 between a vehicle mA and the vehicle mD, which are vehicles (of different group IDs) with a low degree of relation, is larger than an inter-vehicle distance d2 between the vehicle mB and the vehicle mD, which are vehicles (identified by the same group ID) with a high degree of relation, and an inter-vehicle distance d3 between the vehicle mB and the vehicle mC. When the stop position is determined, the pick-up mode determiner 530 notifies the target vehicle of the determined stop position. At this time, notification details may be, for example, an absolute position at which the front end of the vehicle is adjusted or an inter-vehicle distance from a preceding vehicle. When frame lines and the like are provided in the stopping area 310 and a recommended stop position of each vehicle is set, the notification details may be information for designating one of the frame lines in which the vehicle should stop. In the same manner, when a pick-up order is determined, the pick-up mode determiner 530 notifies the target vehicle of the determined pick-up order. At this time, the notification details are information for recognizing another vehicle which is in front of or behind the target vehicle (or waits for the movement to the stopping area 310) (for example, a communication ID, a license plate, vehicle characteristics (a type of vehicle, a size, and a color) and the like).

The pick-up mode determiner 530 sets the inter-vehicle distances d1 to d3, which are upper limits of approach of inter-vehicle distances between vehicles having a high degree of relation, so that a leaving trajectory of the following vehicle of each vehicle is secured and further sets the inter-vehicle distances d1 to d3 in accordance with sizes of items of luggage (for example, lengths of items of luggage) of the occupant candidate of each vehicle. For example, the leaving trajectory is estimated with a sufficient margin from a size and a type of the vehicle and the like recognized using the camera CM or the camera 10 of the vehicle M.

The pick-up mode determiner 530 determines that a vehicle having a large number of occupant candidates, i.e., a vehicle having a high moving cost, is to be stopped at a position closer to the occupant gate Gt in the stopping area 310. In the example shown in FIG. 9, the pick-up mode determiner 530 determines that the vehicle mB is to be stopped at a position closer to the occupant gate Gt because an amount of luggage of the occupant candidate associated with the vehicle mB is large.

The pick-up mode determiner 530 estimates the amount of luggage to be loaded for each vehicle on the basis of various types of information of the storage 540 and determines a stop position so that a vehicle having a large amount of luggage to be loaded is stopped at a position close to the occupant gate Gt of the stopping area 310.

In the example shown in FIG. 9, a moving cost required for one occupant candidate associated with the vehicle mD to carry a large amount of luggage is set to be high. Therefore, the pick-up mode determiner 530 determines that the vehicle mD is to be stopped at a position closer to the occupant gate Gt than the vehicle mA or the vehicle mC.

The pick-up mode determiner 530 may determine a pick-up order on the basis of some or all of occupant classifications. For example, the pick-up mode determiner 530 may determine that the vehicle associated with the occupant candidate having high priority between the vehicle associated with the occupant candidate having the high priority and the vehicle associated with the occupant candidate having a high degree of difficulty when the occupant candidate gets into the vehicle is to be more preferentially stopped at the occupant gate Gt at the time of the getting-into/out process or that the vehicle associated with the occupant candidate having the high degree of difficulty when the occupant candidate gets into the vehicle is to be more preferentially stopped at the occupant gate Gt.

When the pick-up mode is determined, the pick-up mode determiner 530 determines a final pick-up mode by selecting any one of pick-up modes determined using the number of occupant candidates of each vehicle, the number of items or sizes of items of luggage of each vehicle, an occupant classification, or priorities of the occupant candidates at the time of the getting-into/out process or integrating determination results.

### [Pick-Up Mode Related to Arrival Timing]

When a vehicle having a large amount of luggage to be carried and another vehicle having a high degree of relation to the vehicle having the large amount of luggage to be carried move to the stopping area 310, the pick-up mode determiner 530 may determine the pick-up mode so that an arrival time of the other vehicle at the stopping area 310 is later than an arrival time of the vehicle having the large amount of luggage to be carried at the stopping area 310. As shown in FIG. 9, the pick-up mode determiner 530 determines the stop position so that the vehicle mB (an example of a first vehicle) into which an occupant candidate set to have a high degree of difficulty when the occupant candidate gets into the vehicle due to a large amount of luggage to be carried gets is adjacent to the vehicle mD (an example of a second vehicle) into which an occupant candidate having a high degree of relation to the occupant thereof gets and determines the pick-up order so that an arrival time of the vehicle mD at the stopping area 310 is later than an arrival time of the vehicle mB at the stopping area 310. Thereby, it is possible to create a situation in which the occupant candidate of the vehicle mD can easily help load the luggage into the vehicle mB and cause the vehicle mB to more efficiently leave.

The pick-up mode determiner 530 may determine that a waiting position in a vehicle queue is to be adjusted or that a traveling speed is to slow down so that a timing at which the vehicle mD arrives at the stopping area 310 is delayed to create a situation in which the occupant candidate of the vehicle mD can easily help load the luggage into the vehicle mB.

### [Setting of Degrees of Relation Between Occupant Candidates]

Hereinafter, an example in which a group ID is assigned to occupant candidates by the group setting unit 532 will be described. As described above, the pick-up mode determiner 530 determines whether or not it is better to cause a plurality of vehicles to leave at the same time or whether or not it is better to cause the plurality of vehicles to be adjacently stopped with reference to the group ID of the occupant candidate information 542. Therefore, the group setting unit 532 limits an upper limit of the number of vehicles that can be set as the same group in accordance with the allowable number of vehicles and the availability situation in the stopping area 310 and assigns a group ID to the occupant associated with each vehicle. For example, when the number of vehicles capable of being stopped at the same time in the stopping area 310 is 4, the group setting unit 532 sets the group ID so that the number of vehicles associated with the occupant candidates estimated to have a high degree of relation is less than 5. When the number of vehicles associated with the occupant candidates estimated to have a high degree of relation is 5 or more, the group setting unit 532 may set a subgroup of one vehicle and a subgroup of four vehicles or a subgroup of two vehicles and a subgroup of three vehicles so that leaving times of five vehicles are close to each other and set a similar group ID for each subgroup.

For example, the group setting unit 532 sets the group ID by estimating the degree of relation between the occupant candidates on the basis of a pick-up request. When the pick-up request has been transmitted from a communication terminal (for example, a smartphone, a tablet terminal, or the like) used by the occupant candidate, the group setting unit 532 also acquires information about other communication terminals located in a surrounding range of the communication terminal at the time of transmission. The group setting unit 532 sets a group ID by referring to the position information of the communication terminal from which the pick-up request has been transmitted and the position information related to other communication terminals and estimating that nearby users are occupant candidates with a high degree of relation. The position information is, for example, global positioning system (GPS) information, GNSS information, or beacon information. Thereby, the pick-up mode determiner 530 makes a determination so that the pick-up orders of the vehicles associated with the occupant candidates for which the same group ID is set are close to each other.

For example, the group setting unit 532 sets a group ID while determining that a degree of relation between occupant candidates of vehicles is high and it is desirable to set an order so that pick-ups are performed at the same time or similar timings when it is possible to transmit a pick-up request associated with a plurality of vehicles from one communication terminal.

### [Pick-Up Request]

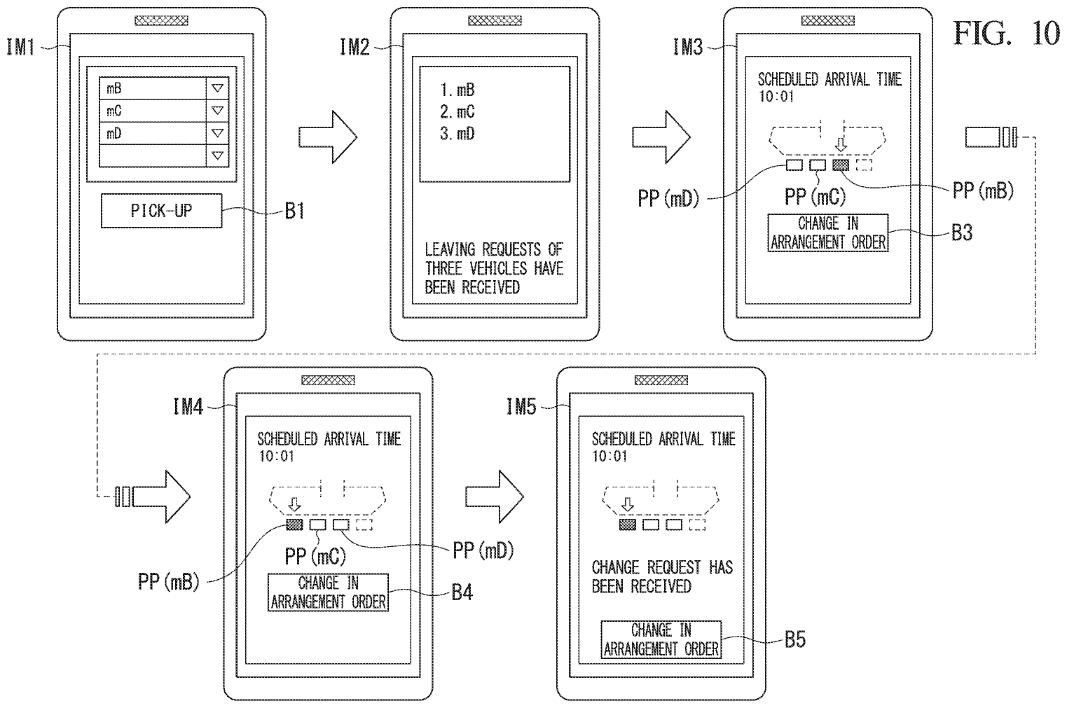

FIG. 10 is an example of the transition of a screen displayed on the external terminal used by the occupant candidate when a pick-up request is transmitted. The pick-up mode determiner 530 provides information about a determined pick-up mode to the external terminal used by the occupant candidate via the communication unit 510. Hereinafter, an example in which any one representative of the occupant candidates of the vehicle mB, the vehicle mC, and the vehicle mD collectively transmits pick-up requests to these three vehicles will be described.

First, the occupant transmits a pick-up request to the communication device 20 of the vehicle, for example, by pressing a pick-up button B1 of a dedicated application for causing the vehicle M to leave or the like. A screen image IM1 of FIG. 10 is an example of a screen displayed by the dedicated application. For example, the screen image IM1 receives an input of a vehicle related to the occupant candidate (for example, a pull-down menu displayed so that vehicles associated with the occupant candidates set with the same group ID can be selected or the like) and displays the pick-up button B1 for transmitting a pick-up request to the vehicle of the received input. When a press of the pick-up button B1 has been received, the pick-up request is transmitted to the communication device 20 of the vehicle. In the screen image IM1, in addition to the display of the pick-up button B1, the designation of the scheduled leaving time may be received or the input of the scheduled arrival time at the stopping area 310 may be received.

At this time, when it is proved that the communication unit 510 has collectively received pick-up requests for a plurality of vehicles stopped in the parking area PA from one external terminal, the degree-of-relation estimater 531 may estimate that a degree of relation between the plurality of vehicles is high on the basis of the pick-up requests. In the following example, a case in which the group setting unit 532 sets the vehicle mB, the vehicle mC, and the vehicle mD for which the pick-up requests have been collectively received in the same group on the basis of the pick-up requests of details shown in the above-described screen image IM1 will be described.

For example, the communication device 20 transmits a departure request to the parking lot management device 400 and the pick-up management device 500 on the basis of the received pick-up request and starts a self-traveling parking event at the time of leaving. For example, the screen image IM2 is an example of a screen displayed when the communication device 20 has transmitted a response to the pick-up request at the start of the self-traveling parking event at the time of leaving and the external terminal has received the response.

### [Change Request]

The pick-up mode determiner 530 determines a pick-up mode on the basis of various types of information acquired by the acquirer 520 and transmits a determination result to a target vehicle via the communication unit 510. Each vehicle transmits information about the scheduled arrival (for example, a scheduled arrival time and a scheduled stop position) to at least the external terminal used by the occupant candidate transmitting the pick-up request. A screen image IM3 of FIG. 10 is an example of a screen for displaying information about the scheduled arrival displayed by the dedicated application. As shown in the screen image IM3, a drawing obtained by imitating the stopping area 310 and the pick-up area 320 and positions PP(mB) to PP(mD) indicating stop positions of vehicles mB to mD are shown, so that the pick-up order and the stop positions are provided to occupant candidates. When a number or a name for identifying a section is set in the stopping area 310, the screen image IM3 may display the number or the name. The screen image IM3 may further display information provided by the pick-up management device 500 such as the number of vehicles which are moving to the stopping area 310.

The pick-up mode determiner 530 may transmit information about an arrangement order of the plurality of vehicles to the external terminal by means of the communication unit 510 and change the pick-up mode in accordance with a received change request when the communication unit 510 has received the change request for changing the pick-up mode of the occupant candidate who is the user of the external terminal before arrival at the stopping area 310. The change request may be limited to the change in the pick-up order within the same group or may require mediation with the occupant candidate who gets into another vehicle.

In this case, the screen image IM3 displays an arrangement order change button B3 for transmitting a change request, a screen image IM4 for receiving an input of a change method is displayed when the press of the arrangement order change button B3 has been received, and a change operation of the occupant candidate (for example, a change operation for changing the order of the vehicle mB and the vehicle mD as shown) is received. When the external terminal used by the occupant candidate detects that the occupant candidate has pressed a change button B4, a change request including change details in the screen image IM4 is transmitted to the pick-up management device 500. When the change request has been received via the communication unit 510, the pick-up mode determiner 530 transmits a result thereof to the target vehicle. Each vehicle transmits information in consideration of the change request to at least the external terminal used by the occupant candidate transmitting the pick-up request. A screen image IM5 is an example of a screen that displays information in consideration of the change request. The screen image IM5 may display, for example, an arrangement order change button B5 having the same function as the arrangement order change button B3 in the screen image IM3.

Although an example in which a change request for making a small adjustment such as a change in the pick-up order in the pick-up mode is received has been described in the above-described example, the pick-up mode determiner 530 may determine that the pick-up order is to be changed by causing a vehicle to be temporarily stopped at a position where the vehicle does not hinder the traveling of another vehicle or causing the vehicle to return to the parking area when a change request requiring a larger adjustment (for example, fine designation of the stop position in the stopping area 310, a condition setting for vehicles simultaneously using the stopping area 310, correction made by an occupant candidate due to an error in a result of estimation performed by the degree-of-relation estimater 531, or the like) has been received.

### [Adjustment of Stop Position]

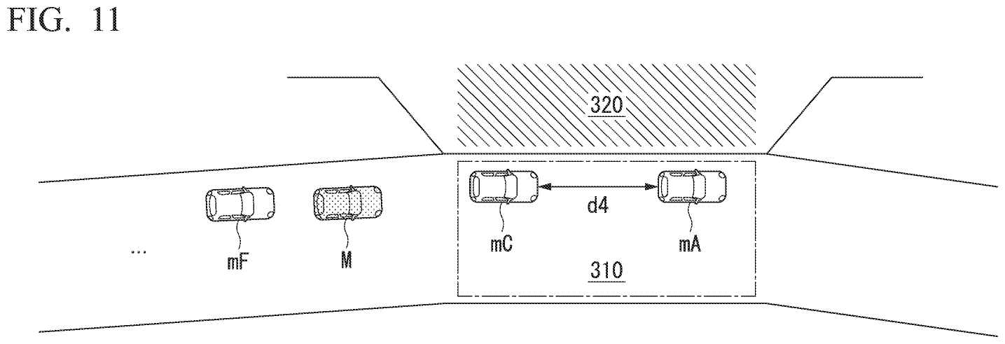

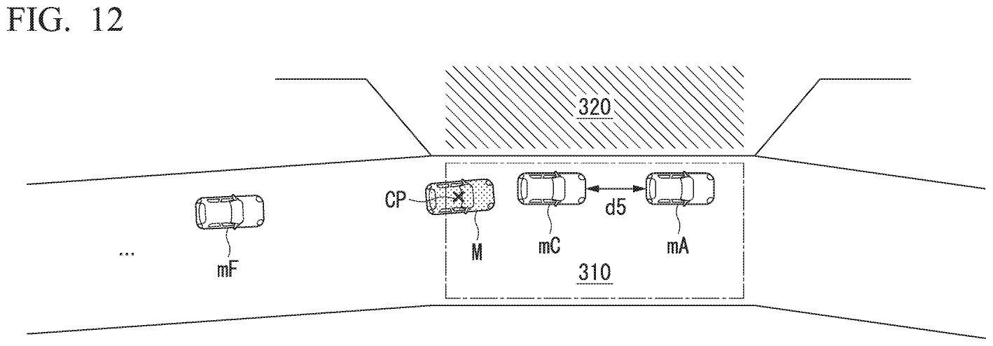

Hereinafter, the adjustment of the stop position in the stopping area 310 by the pick-up mode determiner 530 will be described with reference to FIGS. 11 and 12. FIGS. 11 and 12 are diagrams shown to describe usage situations of the stopping area 310 and the pick-up area 320. FIG. 11 shows a state in which the vehicle mB and the vehicle mD of FIG. 9 shown above have already completed the pick-up and have left the stopping area 310. Further, a case in which a degree of relation between the occupant candidates of the vehicle mC and the vehicle M is high and the same or similar group ID is set will be described.

When another vehicle with a high degree of relation has already stopped in the stopping area 310, the pick-up mode determiner 530 determines that the vehicle M is to stop and wait at a position behind the other vehicle which has already stopped in a traveling direction. The pick-up mode determiner 530 does not cause the vehicle M to be moved to an empty space even when another vehicle with a high degree of relation has already stopped and there is an empty space where the vehicle M can be stopped in the stopping area 310 in front of the other vehicle in the traveling direction (even when an inter-vehicle distance d4 between the vehicle mA and the vehicle mC in FIG. 11 is a sufficient distance for causing the vehicle M to be stopped).

The pick-up mode determiner 530 recognizes vehicles into which occupant candidates having a high degree of relation get as a group and changes a pick-up mode so that an occupant candidate can exceptionally get into the vehicle if a predetermined condition is satisfied even when a following vehicle of the same group cannot stop within the stopping area in a case in which a leading vehicle of the same group has arrived at the stopping area when the vehicles form a vehicle queue and wait for an order to move to the stopping area. For example, changing the pick-up mode includes causing the vehicles to be closer together forward in the traveling direction by further reducing the inter-vehicle distance between the vehicle M and another vehicle or allowing stopping within the stopping area by reducing an inter-vehicle distance between a vehicle waiting in the vehicle queue and the vehicle M and causing the vehicles to be closer together. Changing the pick-up mode may include ending the self-traveling parking event even when the center of gravity CP of the vehicle M is within the stopping area 310, but the rear end of the vehicle M is not within the stopping area 310 or it is necessary for the vehicle to pass through the outside of the stopping area 310 when the occupant candidate gets into the vehicle M as shown in FIG. 12. When a predetermined condition for exceptionally changing the pick-up mode (for example, the condition that stopping is possible within the stopping area 310 when the vehicle mC moves forward or the vehicle mC makes the inter-vehicle distance smaller as described above and that the process in which the occupant candidate gets into the vehicle mC or the loading of luggage into the vehicle mC is not started or can be interrupted) is satisfied, the pick-up mode determiner 530 may determine that the stop position of the vehicle mC is also to be changed (i.e., the vehicle mC is advanced) so that an inter-vehicle distance d5 less than the inter-vehicle distance d4 is formed between the vehicle mA and the vehicle mC.

### [Process Flow]

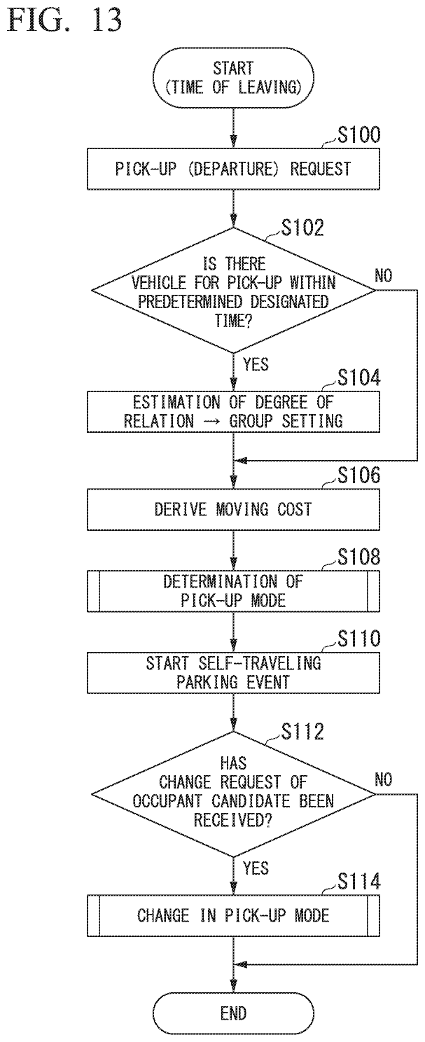

FIGS. 13 to 15 are flowcharts showing an example of a flow of a series of processes of the pick-up management device 500 according to the first embodiment. In the following description, a case in which the pick-up management device 500 manages the pick-up of the vehicle M will be described.

FIG. 13 is a flowchart showing an example of a flow of a series of processes to be executed by the pick-up management device 500 when the self-traveling parking event at the time of leaving is started. First, the communication unit 510 receives a departure request from the vehicle M (step S100). Next, the acquirer 520 determines whether or not there is another vehicle for a pick-up within a predetermined designated period of time (step S102) and estimates a degree of relation with respect to the number of occupant candidates, the number of items or sizes of items of luggage for each of the vehicles including the other vehicle and the vehicle M, sets a group ID based on the estimated degree of relation, and causes the set group ID to be considered in the occupant candidate information 542 when there is another vehicle (step S104). In the processing of step S104, in addition to the above-described details, the degree of relation may be further estimated using position information of the terminal device transmitting the pick-up request. If there is no other vehicle for a pick-up within the predetermined designated period of time, the process proceeds to step S106.

Next, the acquirer 520 refers to an occupant classification of the occupant candidate which is associated with the vehicle M (or which is likely to be associated with the vehicle M) with reference to the occupant candidate information 542 and derives a moving cost of the occupant candidate associated with the vehicle M (step S106) and causes the moving cost to be stored as vehicle information 544. Next, the pick-up mode determiner 530 determines the pick-up mode of the vehicle M (step S108). Details of the processing of step S108 will be described below. Next, the communication unit 510 causes a self-traveling parking event to be started at the time of leaving by transmitting information about the pick-up mode determined by the pick-up mode determiner 530 to the vehicle M (step S110). Next, the communication unit 510 determines whether or not a change request of the occupant candidate has been received (step S112). When it is determined that the change request has been received, the pick-up mode determiner 530 changes a pick-up mode in accordance with a change request (step S114). When it is determined that the change request has not been received, the process of the present flowchart ends.

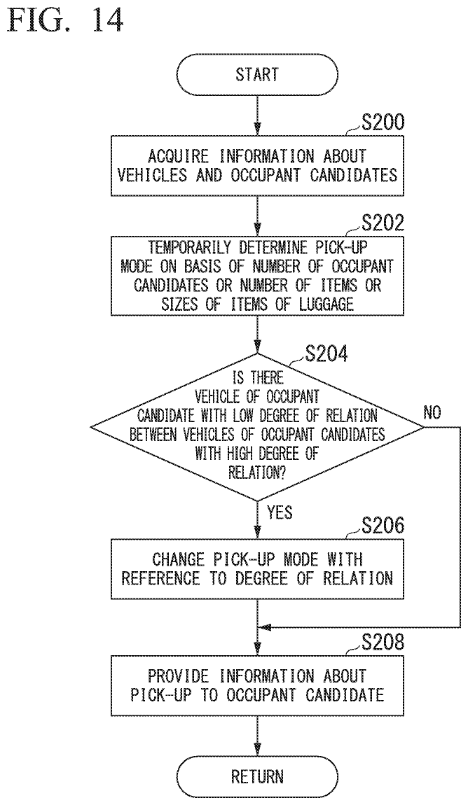

FIG. 14 is a flowchart showing an example of the flow of a process in which the pick-up mode determiner 530 determines a pick-up mode. The process of the present flowchart is performed in steps S108 and S114 of the flowchart of FIG. 13 described above.

First, the pick-up mode determiner 530 acquires the vehicle information 544 and the occupant candidate information 542 as information about the vehicles and the occupant candidates acquired by the acquirer 520 (step S200) and determines the pick-up mode of the vehicle M on the basis of at least some of the number of occupant candidates of each vehicle, the number of items or sizes of items of luggage of each vehicle, and priorities of occupant candidates at the time of a getting-into/out process (step S202). In step S202, determining the pick-up mode includes, for example, determining a stop position so that a plurality of vehicles having a high degree of relation between the occupant candidates are stopped at mutually adjacent positions or determining a stop position so that a vehicle having a large number of occupant candidates is stopped at a position close to the occupant gate Gt, and determining a pick-up order so that an arrival time of a second vehicle at the stopping area 310 is later than a first vehicle having a large amount of luggage to be loaded. Next, the pick-up mode determiner 530 determines whether or not there is a vehicle of an occupant candidate with a low degree of relation between vehicles of occupant candidates with a high degree of relation in the pick-up mode determined in step S202 (step S204). When it is determined that there is a vehicle of an occupant candidate with a low degree of relation between the vehicles, the pick-up mode is changed with reference to the degree of relation in the occupant candidate information 542 (step S206). In step S206, changing the pick-up mode includes, for example, determining a stop position so that a plurality of vehicles of occupant candidates having a high degree of relation are stopped at mutually adjacent positions. When it is determined that there is no vehicle of an occupant candidate having a low degree of relation between the vehicles, the process proceeds to step S208. Next, the pick-up mode determiner 530 provides information to the occupant candidate by transmitting information about the determined pick-up mode to an external device such as an external terminal used by the occupant candidate via the communication unit 510 (step S208). Accordingly, the description of the process of the present flowchart ends.

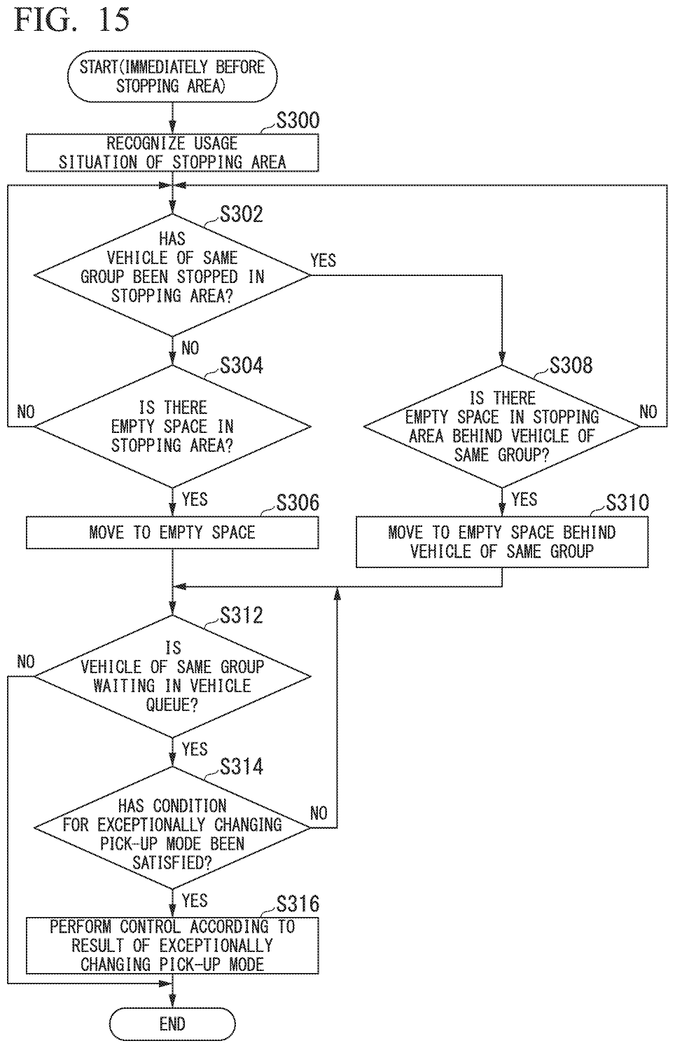

FIG. 15 is a flowchart showing an example of a flow of a process of the pick-up management device 500 when the vehicle M arrives immediately before the stopping area 310 and is about to stop at the stopping area 310.

First, the communication unit 510 receives a usage situation of the stopping area 310 (such as the allowable number of vehicles and an availability situation) (step S300). At this time, for example, the usage situation of the stopping area 310 may be provided by transmitting the usage situation of the stopping area 310 recognized by the recognizer 130 of the vehicle M to the pick-up management device 500. Next, the pick-up mode determiner 530 determines whether or not another vehicle of the same group has already stopped in the stopping area 310 (step S302). When it is determined that the other vehicle of the same group have not stopped therein, the pick-up mode determiner 530 determines whether or not there is an empty space in the stopping area 310 where the vehicle M can be stopped (step S304). When it is determined that there is an empty space, the pick-up mode determiner 530 determines that the vehicle M is to be moved to the empty space, transmits an instruction thereof to the communication device 20 of the vehicle M, and causes the automated driving control device 100 to control the vehicle M (step S306). If it is determined that there is no empty space, the pick-up mode determiner 530 performs the processing of step S302 again when a fixed period of time has elapsed.

When it is determined that the other vehicle of the same group has stopped therein in step S302, the pick-up mode determiner 530 determines whether or not there is an empty space in the stopping area 310 behind the other vehicle (step S308). When it is determined that there is no empty space, the pick-up mode determiner 530 performs the processing of step S302 again when a fixed period of time has elapsed. When it is determined that there is an empty space, the pick-up mode determiner 530 causes the vehicle M to moves to an empty space behind the other vehicle of the same group (step S310).

After the processing of step S306 or step S310, it is determined whether or not a vehicle of the same group is present in a waiting vehicle queue in the order of movement to the stopping area 310 (step S312). When it is determined that the vehicle of the same group is waiting, the pick-up mode determiner 530 determines whether or not a condition for exceptionally changing the pick-up mode is satisfied (step S314). If the condition is not satisfied, the pick-up mode determiner 530 performs the processing of step S312 again when a fixed period of time has elapsed. When the condition is satisfied, the pick-up mode determiner 530 exceptionally changes the pick-up mode so that the occupant candidate can get into the vehicle and transmits change details thereof to the automated driving control device 100 so that the automated driving control device 100 controls the vehicle M (step S316). When it is determined that no vehicle of the same group is waiting in the processing of step S312, the process of the present flowchart ends.

As described above, the pick-up management device 500 of the first embodiment includes the acquirer 520 configured to acquire information about a situation of movement of a vehicle from the parking area PA to the stopping area 310, information indicating a situation of the stopping area 310, and information about occupant candidates who are present in or are approaching the stopping area 310; and the pick-up mode determiner 530 configured to associate one or more occupant candidates, the number of items or sizes of items of luggage, or priorities of the occupant candidates at the time of the getting-into/out process with the vehicle on the basis of the information acquired by the acquirer 520 and determine a pick-up mode in the stopping area 310 of the vehicle on the basis of at least some of the number of occupant candidates for each vehicle, the number of items or the sizes of the items of the luggage for each vehicle, and the priorities of the occupant candidates at the time of the getting-into/out process in the stopping area 310 when a predetermined number of vehicles or more are predicted to move to the stopping area 310 within a predetermined period of time, thereby implementing smoother picking up.

According to the pick-up management device 500 of the first embodiment, a more suitable pick-up mode can be implemented in accordance with a degree of relation between the occupant candidates within the pick-up area 320 set by the degree-of-relation estimater 531 of the pick-up mode determiner 530.

### Second Embodiment

Hereinafter, a vehicle system 1A according to a second embodiment can be implemented by a configuration similar to that of the vehicle system 1 according to the first embodiment. Hereinafter, only differences will be described using the names and the reference signs that are the same as those of the components included in the vehicle system 1 according to the first embodiment.

The vehicle system 1A according to the second embodiment will be described as a system of implementing a process in which an in-vehicle device of each vehicle communicates with a nearby vehicle and autonomously travels within a parking lot in a state in which there is no function corresponding to the pick-up management device 500 in the visiting destination facility. An automated driving control device 100A of the second embodiment is another example of a “pick-up management device” and a communication device 20 is an example of a “communication unit”.

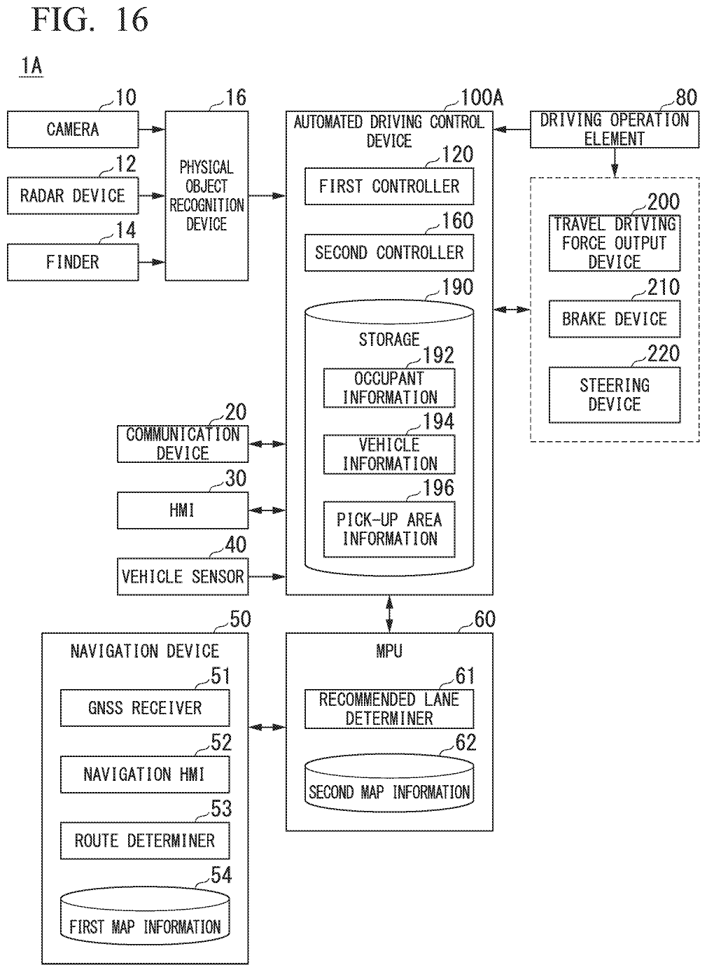

FIG. 16 is a configuration diagram of the vehicle system 1A. The automated driving control device 100A of the vehicle system 1A further includes a storage 190 in addition to the automated driving control device 100 of the first embodiment. The storage 190 has a function similar to that of the storage 540 according to the first embodiment. The storage 190 includes, for example, occupant information 192, vehicle information 194, and pick-up area information 196. The occupant information 192 is information similar to the occupant candidate information 542 of the first embodiment, and is information limited to an occupant of a vehicle M and an occupant having a high degree of relation to the occupant of the vehicle M. The vehicle information 194 is information similar to the vehicle information 544 of the first embodiment, and is information associated with an occupant of the occupant information 192. The pick-up area information 196 is information similar to the pick-up area information 546 of the first embodiment.

The occupant information 192 includes information about at least the vehicle M and representative occupant candidates (for example, an owner of each vehicle, a borrower of each vehicle, a person who is scheduled to sit in a driver's seat of each vehicle, and a person who has a record in which he/she got into the vehicle in the past). A part or all of the information included in the vehicle information 194 (particularly, the presence/absence of another vehicle having a high degree of relation and the designation of the vehicle) may be input from such representative occupant candidates.

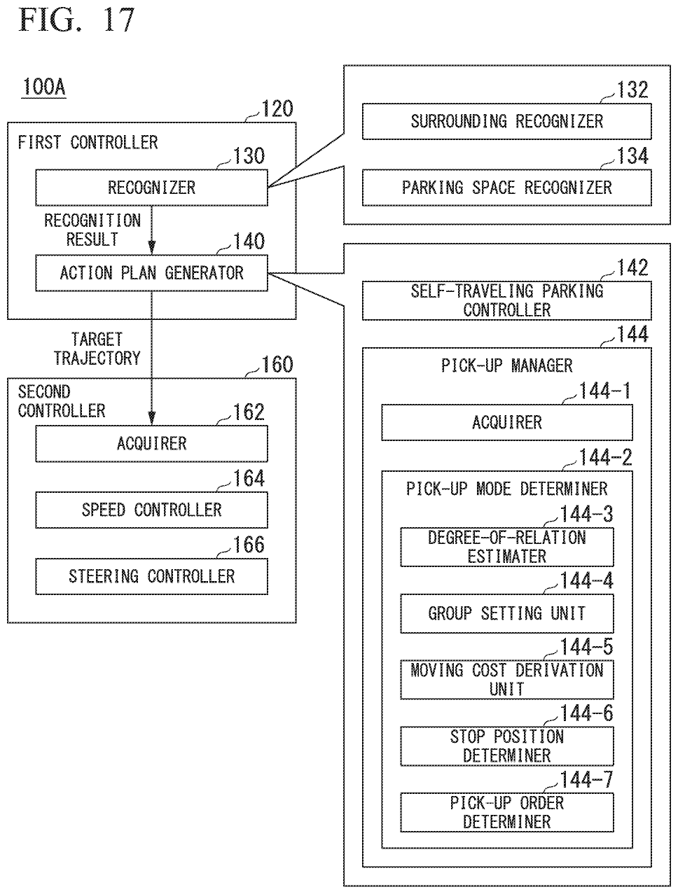

FIG. 17 is a functional configuration diagram of a first controller 120A and a second controller 160 of the automated driving control device 100A. The first controller 120A of the second embodiment further includes a pick-up manager 144 in addition to the first controller 120 of the first embodiment. The pick-up manager 144 includes, for example, an acquirer 144-1 and a pick-up mode determiner 144-2.

The acquirer 144-1 has a function similar to that of the acquirer 520 of the first embodiment. The pick-up mode determiner 144-2 has a function similar to that of the pick-up mode determiner 530 of the first embodiment.

The pick-up mode determiner 144-2 includes, for example, a degree-of-relation estimater 144-3, a group setting unit 144-4, a moving cost derivation unit 144-5, a stop position determiner 144-6, and a pick-up order determiner 144-7. The degree-of-relation estimater 144-3 has a function similar to that of the degree-of-relation estimater 531 of the first embodiment. The group setting unit 144-4 has a function similar to that of the group setting unit 532 of the first embodiment. The moving cost derivation unit 144-5 has a function similar to that of the moving cost derivation unit 533 of the first embodiment.

The degree-of-relation estimater 144-3 estimates a degree of relation with reference to the occupant information 192. When the input of information about the degree of relation has already been received by a representative occupant candidate of the target vehicle, the degree-of-relation estimater 144-3 may omit an estimation process by preferentially using the received information.

The stop position determiner 144-6 has a function similar to that of the stop position determiner 534 of the first embodiment. The pick-up order determiner 144-7 has a function similar to that of the pick-up order determiner 535 of the first embodiment.

When the communication device 20 of the automated driving control device 100A receives a pick-up request, information included in the received pick-up request is output to the pick-up manager 144. The pick-up manager 144 refers to various types of information of the storage 190, determines the pick-up mode, and starts a self-traveling parking event. At this time, when another vehicle (hereinafter referred to as a “master vehicle”) that has already received a pick-up request as in the vehicle M and mediates the order of vehicles traveling in the stopping area 310 is present, a request for requesting the master vehicle to determine the pick-up mode of the host vehicle is transmitted and the vehicle M is driven in accordance with a response received from the master vehicle. If the master vehicle is not present when the self-traveling parking event is started or if the current master vehicle leaves the stopping area 310 and the transfer of its role is requested, the automated driving control device 100A of the vehicle M determines that the host vehicle is to serve as a master vehicle and determines the pick-up mode of a plurality of vehicles including the host vehicle.

The pick-up manager 144 instructs a specific vehicle to stop or slow down as necessary so that the vehicles do not simultaneously move to the same position on the basis of a positional relationship between a plurality of vehicles. When the times at which a plurality of vehicles are desired to arrive at the stopping area 310 overlap each other, the pick-up manager 144 adjusts a scheduled arrival time in accordance with a reception order of the pick-up requests or by performing mediation with each occupant candidate.

As described above, the pick-up manager 144 of the automated driving control device 100A according to the second embodiment has effects similar to the pick-up management device 500 of the first embodiment and can implement smoother picking up with respect to occupants with reference to the occupant information 192 associated with vehicles.

### [Hardware Configuration]

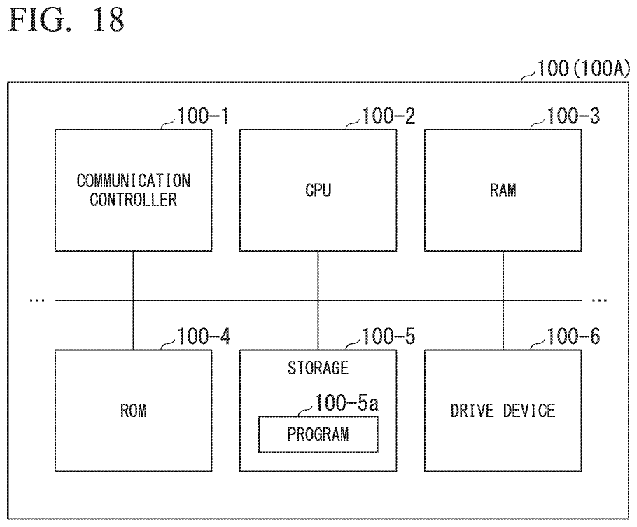

FIG. 18 is a diagram showing an example of a hardware configuration of the automated driving control device 100 of the embodiment. As shown in FIG. 18, the automated driving control device 100 (100A) has a configuration in which a communication controller 100-1, a CPU 100-2, a random access memory (RAM) 100-3 used as a working memory, a read only memory (ROM) 100-4 storing a boot program and the like, a storage 100-5 such as a flash memory or a hard disk drive (HDD), a drive device 100-6, and the like are mutually connected by an internal bus or a dedicated communication line. The communication controller 100-1 communicates with components other than the automated driving control device 100. A program 100-5a executed by the CPU 100-2 is stored in the storage 100-5. A portable storage medium such as an optical disk (for example, a computer-readable non-transitory storage medium) is attached to the drive device 100-6. The storage 100-5 stores the program 100-5a to be executed by the CPU 100-2. This program is loaded to the RAM 100-3 by a direct memory access (DMA) controller (not shown) or the like and executed by the CPU 100-2. The program 100-5a to be referred to by the CPU 100-2 may be stored in the portable storage medium attached to the drive device 100-6 or may be downloaded from another device via a network. Thereby, one or both of the first controller 120 (the first controller 120A) and the second controller 160 are implemented.

The embodiment described above can be represented as follows.

A pick-up management device including:

a storage configured to store a program; and

a hardware processor,

wherein the hardware processor executes the program stored in the storage to:

acquire information about a situation of movement of a vehicle from a parking area to a stopping area, information indicating a situation of the stopping area, and information about occupant candidates who are present in or are approaching the stopping area; and

associate one or more occupant candidates or one or more items of luggage with the vehicle on the basis of the acquired information and determine a pick-up mode in the stopping area of the vehicle on the basis of at least some of the number of occupant candidates for each vehicle in the stopping area, the number of items or sizes of items of the luggage of each vehicle, and priorities when the occupant candidates get into and out of the vehicle when a predetermined number of vehicles or more are predicted to move to the stopping area within a predetermined period of time.

Although modes for carrying out the present invention have been described above using embodiments, the present invention is not limited to the embodiments, and various modifications and substitutions can also be made without departing from the scope and spirit of the present invention.

What is claimed is:

1. A pick-up management device comprising:
an acquirer configured to acquire first information about a situation of movement of a vehicle from a parking area to a stopping area, second information indicating a situation of the stopping area, and third information about occupant candidates who are present in or are approaching the stopping area; and
a pick-up mode determiner configured to associate one or more occupant candidates or one or more items of luggage with the vehicle on the basis of at least one of the first information, the second information, and the third information and determine a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

2. The pick-up management device according to claim 1,
wherein the pick-up mode determines a stop position of the vehicle.

3. The pick-up management device according to claim 2,
wherein the pick-up mode determiner estimates degrees of relation between the occupant candidates on the basis of at least one of the first information, the second information, and the third information and determines the stop position so that a plurality of vehicles with a high degree of relation between the occupant candidates are stopped at mutually adjacent positions.

4. The pick-up management device according to claim 2,
wherein the pick-up mode determiner causes a vehicle having a large number of occupant candidates to be stopped at a position near an occupant gate of the stopping area on the basis of the acquired information.

5. The pick-up management device according to claim 2,
wherein the pick-up mode determiner estimates an amount of luggage to be loaded for each vehicle on the basis of at least one of the first information, the second information, and the third information and causes a vehicle having a large amount of luggage to be loaded to be stopped at a position near an occupant gate of the stopping area.

6. The pick-up management device according to claim 1,
wherein the pick-up mode determines a pick-up order of the vehicles.

7. The pick-up management device according to claim 6,
wherein the pick-up mode determiner estimates an amount of luggage to be loaded for each vehicle on the basis of at least one of the first information, the second information, and the third information and determines the pick-up order so that an arrival time of a second vehicle at the stopping area is later than an arrival time of a first vehicle at the stopping area when the first vehicle having a large amount of luggage to be loaded and the second vehicle with a high degree of relation to an occupant candidate of the first vehicle move to the stopping area.

8. The pick-up management device according to claim 7,
wherein the pick-up mode determiner further determines the pick-up order on the basis of an occupant classification of the occupant candidate that is ascertained on the basis of at least one of the first information, the second information, and the third information.

9. The pick-up management device according to claim 8,
wherein the occupant classification includes at least one of a gender, an age, a degree of difficulty when the occupant candidate gets into the vehicle, the presence or absence of the next schedule and a scheduled time thereof, and a scheduled movement distance.

10. The pick-up management device according to claim 6,
wherein the pick-up mode determiner estimates degrees of relation between the occupant candidates on the basis of at least one of the first information, the second information, and the third information and determines the pick-up order so that a vehicle associated with an occupant candidate having a low degree of relation to an occupant candidate related to a vehicles of occupant candidates having a high degree of relation is not stopped between the vehicles having the high degree of relation between the occupant candidates.

11. The pick-up management device according to claim 6,
wherein, when the vehicles arriving at the stopping area form a vehicle queue and wait in front of the stopping area, the pick-up mode determiner causes the vehicles to be arranged at positions in the vehicle queue according to the pick-up order set by the pick-up mode determiner.

12. The pick-up management device according to claim 6,
wherein, when it is proved that a communication unit that communicates with an external terminal has received a pick-up request for moving the vehicle from the parking area and have the occupant candidate ride on the vehicle at the stopping area, the acquirer estimates the degree of relation of the occupant candidate on the basis of position information of the external terminal transmitting the pick-up request received by the communication unit.

13. The pick-up management device according to claim 12,
wherein the acquirer acquires the position information of the external terminal transmitting the pick-up request as information indicating a situation of the stopping area, and
wherein the pick-up mode determiner estimates the degree of relation of the occupant candidate using the external terminal on the basis of the position information.

14. The pick-up management device according to claim 12,
wherein, when it is proved that the communication unit has collectively received pick-up requests for a plurality of vehicles to be stopped in the parking area from one external terminal, the pick-up mode determiner estimates the degree of relation between the plurality of vehicles on the basis of the pick-up requests.

15. The pick-up management device according to claim 14,
wherein the pick-up mode determiner transmits information about an arrangement order of the plurality of vehicles to the external terminal by means of the communication unit and changes the pick-up mode in accordance with a received change request when the communication unit has received the change request for changing the pick-up mode of a user of the external terminal from the external terminal before arrival at the stopping area.

16. The pick-up management device according to claim 12,
wherein the pick-up mode manager sets an upper limit of approach of an inter-vehicle distance between the vehicles having a high degree of relation in accordance with a leaving trajectory and sizes of items of luggage of a following vehicle.

17. The pick-up management device according to claim 12,
wherein, when another vehicle having a high degree of relation is already stopped in the stopping area, the pick-up mode determiner causes the vehicle to stop and wait behind the other vehicle.

18. The pick-up management device according to claim 14,
wherein the pick-up mode determiner recognizes vehicles into which occupant candidates having a high degree of relation get as a group and causes a following vehicle of the same group to stop within the stopping area if a predetermined condition is satisfied in a case in which a leading vehicle of the same group has arrived at the stopping area when the vehicle is waiting for an order to move to the stopping area.

19. The pick-up management device according to claim 18,
wherein the pick-up mode determiner limits an upper limit of the number of vehicles capable of being set as the same group in accordance with the allowable number of vehicles and an availability situation at the stopping area.

20. The pick-up management device according to claim 18,
wherein the pick-up mode determiner sets the occupant candidates joining the same event in the same group.

21. The pick-up management device according to claim 1,
wherein the pick-up mode determiner provides information about the determined pick-up mode to an external terminal used by the occupant candidate via a communication unit.

22. A pick-up control method comprising:
acquiring, by a computer, first information about a situation of movement of a vehicle from a parking area to a stopping area, second information indicating a situation of the stopping area, and third information about occupant candidates who are present in or are approaching the stopping area;
associating, by the computer, one or more occupant candidates or one or more items of luggage with the vehicle on the basis of at least one of the first information, the second information, and the third information; and
determining, by the computer, a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.

23. A computer-readable non-transitory storage medium storing a program for causing a computer to:
acquire first information about a situation of movement of a vehicle from a parking area to a stopping area, second information indicating a situation of the stopping area, and third information about occupant candidates who are present in or are approaching the stopping area;
associate one or more occupant candidates or one or more items of luggage with the vehicle on the basis of at least one of the first information, the second information, and the third information; and
determine a pick-up mode in the stopping area of the vehicle on the basis of at least some of the number of occupant candidates, the number of items or sizes of items of the luggage, and priorities of the occupant candidates included in the third information associated with each vehicle in the stopping area when a predetermined number of vehicles or more are predicted to move to the stopping area within a predetermined period of time.
